(19) United States
(12) Patent Application Publication
(10) Pub. No.: US 2006/0255735 A1
(43) Pub. Date: Nov. 16, 2006

(54) METHOD OF FORMING BANK, METHOD OF FORMING FILM PATTERN, SEMICONDUCTOR DEVICE, ELECTRO OPTIC DEVICE, AND ELECTRONIC APPARATUS

(75) Inventors: Katsuyuki MORIYA, Suwa (JP); Toshimitsu HIRAI, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/381,834

(22) Filed: May 5, 2006

(30) Foreign Application Priority Data
May 13, 2005 (JP) 2005-140739
Oct. 21, 2005 (JP) 2005-306727

(51) Int. Cl. H01J 17/02

(52) U.S. Cl. 313/610

(57) ABSTRACT

A method of forming a bank that partitions a region for forming a film pattern made of a functional liquid, includes: forming a bank film made of a photo resist by applying a photo resist liquid onto a substrate and drying the photo resist liquid; performing a lyophobic treatment for the bank film by using a lyophobic treatment gas and plasma; reducing a lyophobic property by selectively applying ultraviolet rays to the bank film after the lyophobic treatment with a mask; selectively exposing the bank film after the lyophobic treatment to light with the mask; developing and patterning the bank film after reducing the lyophobic property and exposing the bank film to light so as to form the bank; wherein the lyophobic property is reduced and the bank film is exposed to light continuously or at the same time with the same mask.

### BACKGROUND OF THE INVENTION

1. Technical Field

The present invention relates to a method of forming a bank, a method of forming a film pattern, a semiconductor device, an electro optic device, and an electronic apparatus.

2. Related Art

A semiconductor device including circuit wiring to which a thin film (film pattern) made of a conductor is provided, a thin film such as an insulating film that covers the circuit wiring, and a thin film made of a semiconductor, which are stacked on a substrate, are known heretofore. As an efficient method of forming a thin film in such a semiconductor device, a droplet discharging method (inkjet method) according to JP-A-11-274671 is known. In this method, droplets of a functional liquid including a thin film material as dispersoid are discharged from a droplet discharging head, and the functional liquid that has landed is dried for removing the dispersion medium from it, so that a thin film is formed.

If a thin film functioning as a film pattern is formed by a droplet discharging method, usually, a bank to partition a region for forming a film pattern is formed, and a functional liquid is discharged towards the region for forming a film pattern, which is in a concave section partitioned by the bank. Then, the functional liquid that has landed on the region for forming a film pattern in the concave section is dried, forming a thin film. Thus, a film pattern is formed.

It is desirable that all the droplets of a functional liquid discharged so as to land in the concave section come into the concave section. However, some droplets can be placed on the top surface of the bank. In this case, in order for the droplets to flow into the concave section without adhering to the top surface of the bank, it is necessary to modify the property of the top surface of the bank into being lyophobic to the functional liquid. Here, in order to modify the property of the top surface of the bank, a lyophobic treatment is generally performed for a bank material composed of a photo resist material after the material is patterned into the final shape.

In this method, however, the internal side surface of the bank, which is the internal side surface of the concave section, is provided with lyophobic property. This suppresses the droplet placed on the top surface of the bank flowing down into the concave section.

As a technique to solve such a problem it is conceivable that a lyophobic treatment is performed for the surface of the bank material in a state of a photo resist film before patterned into the final shape, and then the material is patterned into the bank shape.

In this case, however, when the bank material is exposed to light and developed for patterning, a developer does not sufficiently penetrate the portion to be developed and removed since the property of the surface of the bank material has been modified into being lyophobic. Hence, the pattern accuracy of a bank obtained after developing is reduced, and sufficient accuracy is sometimes not achieved for a film pattern obtained from the bank. Part of the photo resist is sometimes not removed by developing, remaining in the concave section as the residue.

In particular, a problem is raised if the bank is formed for forming a wiring pattern of the upper layer, which is deposited as a second or higher layer, and a contact hole is formed between the wiring pattern of the upper layer and the conductive section of the lower layer to establish continuity between them. In this case, if the above-mentioned residue remains in the region of forming a wiring pattern of the upper layer, a contact hole sometimes cannot be formed appropriately. This may result in poor continuity.

As described above, the droplet discharging method is preferable for efficiently forming a thin film. Hence, if a bank is formed on the assumption that the droplet discharging method is used, efficiency in productivity is needed in forming the bank, as a matter of course.

### SUMMARY

An advantage of the invention is to provide a method of forming a bank that solves a disadvantage caused by a lyophobic treatment of the bank without impairing the productivity, a method of forming a film pattern using the obtained bank, and further a method of manufacturing a semiconductor device, an electro optic device, and an electronic apparatus.

A method of forming a bank according to one aspect of the invention is a method of forming a bank that partitions a region for forming a film pattern made of a functional liquid. The method includes: forming a bank film made of a photo resist by applying a photo resist liquid onto a substrate and drying the photo resist liquid, performing a lyophobic treatment for the bank film by using a lyophobic treatment gas and plasma; reducing the lyophobic property by selectively applying UV rays to the bank film after the lyophobic treatment with a mask; selectively exposing the bank film after the lyophobic treatment to light with the mask; developing and patterning the bank film after reducing the lyophobic property and exposing the bank film to light so as to form the bank; wherein the lyophobic property is reduced and the bank film is exposed to light continuously or at the same time with the same mask.

According to this method of forming a bank, the lyophobic property of a desired portion, namely, a portion to be removed by developing is reduced by exposure to ultraviolet (UV) radiation before developing, and therefore, in developing, the surface of the portion is easily wetted by a developer and the developer penetrates into the portion, since the method includes a process of reducing the lyophobic property by selectively applying UV rays to the bank film after the lyophobic treatment with a mask, a process of selectively exposing the bank film after the lyophobic treatment to light with the mask, and a process of developing and patterning the bank film after reducing the lyophobic property and exposing the bank film to light so as to form the bank. Accordingly, the portion to be removed is reliably removed by developing. Thus, this method secures good pattern accuracy of the bank as well as prevents a disadvantage of the residue remaining in the concave section.

It is unnecessary to remove or change a mask between the process of reducing the lyophobic property and the process of exposure to light since these processes are performed continuously or at the same time with the same mask. Thus, productivity can be improved.

In the above method of forming a bank, it is preferable to perform the process of expose to light after the process of reducing the lyophobic property if these processes are continuously performed with the same mask.

Performing the process of reducing lyophobic property before the process of exposure to light can further improve lyophobic property compared to performing the process of reducing lyophobic property after the process of exposure to light.

In the above method of forming a bank, it is preferable to use a photosensitive material that includes any one of polysilazane, polysilane, and polysiloxane and either a photoacid generator or a photobase generator and functions as a positive photo resist.

If such a photosensitive material is used as a photo resist material liquid, the bank obtained from the this material is mainly made of polysiloxane, which is inorganic. Therefore, the bank exhibits high heat resistance compared to an organic hank obtained from an organic material, and is preferred in burning metal micro particles to form a wiring pattern.

In the method of forming a bank according to one aspect of the invention it is preferable to use a photosensitive material that includes an organic material and either a photoacid generator or a photobase generator and functions as a positive photo resist.

If heat resistance is unnecessary, using such a photosensitive material as the photo resist material liquid causes a bank obtained from this material to be organic. Therefore, this bank can have a high film thickness compared to an inorganic bank obtained from an inorganic material. Using the above-mentioned photosensitive material is particularly preferable for filling in uneven portions caused by structures such as elements and wiring on the substrate with the bank so as to flatten the top surface.

In the method of forming a film pattern according to one aspect of the invention, a bank obtained by the above method of forming a bank is used, a functional liquid is placed in the region of forming a film pattern partitioned by the bank, and the placed liquid is dried, forming a film pattern.

According to this method of forming a film pattern, a film pattern with good accuracy is obtained since the film pattern is formed by using a bank with good accuracy as described above.

A semiconductor device according to one aspect of the invention includes a film pattern obtained by the above method of forming a film pattern.

According to this semiconductor device, good characteristics are obtained due to the film pattern since the semiconductor device includes the film pattern with good pattern accuracy as described above.

In the semiconductor device according to one aspect of the invention, it is desirable that the semiconductor device constitute a transistor having a coplanar structure, the film pattern constitute a source electrode or a drain electrode, and a material including an organic material be used as the photo resist material liquid.

According to this semiconductor device, a gate electrode, a source electrode, and a drain electrode are formed after a semiconductor film is formed since the semiconductor device has a coplanar structure. The bank for forming the source electrode and the drain electrode may be organic since the bank is never exposed to high temperatures when the source electrode and the drain electrode are formed. Using an organic material as the material of the bank allows the bank to have a high film thickness compared to using an inorganic material. In forming a bank for forming film patterns of the source electrode and the drain electrode, this therefore makes it easier to fill in structures such as elements and wiring on the substrate with the bank so as to flatten the top surface.

An electro optic device according to one aspect of the invention includes the above semiconductor device.

This electro optic device has good characteristics since it includes the semiconductor device with good characteristics.

An electronic apparatus according to one aspect of the invention includes the above electro optic device.

This electronic apparatus has good characteristics since it includes the electro optic device with good characteristics.

### BRIEF DESCRIPTION OF THE DRAWINGS

The invention will be described with reference to the accompanying drawings, wherein like numbers reference like elements.

FIG. 1 is a perspective view that shows the schematic structure of a droplet discharging device according to a first embodiment.

FIG. 2 is a schematic sectional view that explains the principle of discharging a liquid material based on a piezo method.

FIG. 3 is a plan view that shows the schematic structure of a main part of a TFT array substrate.

FIGS. 4A and 4B are side sectional views that show a main part of the TFT.

FIGS. 5A to 5D are schematic views for explaining a method of forming a bank.

FIG. 6 is a schematic structure view of a plasma processing device.

FIGS. 7A to 7E are schematic views for explaining the method of forming a bank.

FIGS. 8A to 8D are schematic views for explaining the method of forming a wiring pattern.

FIG. 9 is a schematic view for explaining the method of forming a wiring pattern of a second embodiment.

FIGS. 10A to 11C are schematic views for explaining a third embodiment.

FIG. 12 is a flow chart that shows a method of forming a wiring pattern according to a fourth embodiment.

FIG. 13 is a schematic sectional view that shows a main part of a TFT according to a fifth embodiment.

FIG. 14 is a flow chart that shows manufacturing processes of the TFT.

FIGS. 15A to 17C are schematic views for explaining a method of manufacturing the TFT.

FIG. 18 is a plan view of a liquid crystal display of another embodiment, seen from the side of the opposing substrate.

FIG. 19 is a sectional view taken along the line H-H′ in FIG. 18.

FIG. 20 is an equivalent circuit diagram showing a liquid crystal display.

FIG. 21 is a partial enlarged sectional view of the liquid crystal display.

FIG. 22 is an exploded perspective view of a noncontact type card medium.

FIG. 23 is an outline view that shows a specific example of an electronic apparatus.

### DESCRIPTION OF EXEMPLARY EMBODIMENTS

Embodiments of the invention will be described. Here, in each of figures, contraction scales of layers and parts may be different so as to have recognizable size on each of figures.

### First Embodiment

First an embodiment in which ink (functional liquid) for wiring pattern (film pattern) containing conductive micro particles is discharged as droplets from a nozzle of a droplet discharging head by a droplet discharging method so as to form a wiring pattern (film pattern) in a concave section, namely in a region partitioned by the banks, formed on a substrate corresponding to the wiring pattern, as the method of forming a film pattern according to one embodiment of the invention, will now be described.

Here, as the ink (functional liquid) for wiring pattern, a dispersion liquid containing conductive micro particles dispersed in a dispersion medium is used. In this embodiment, as conductive micro particles, metal micro particles containing at least one of gold, silver, copper, aluminum, chromium, manganese, molybdenum, titan, palladium, tungsten, and nickel, these oxides, and micro particles of conductive polymers and superconductors are used. The surface of these conductive micro particles may be coated with an organic material for improvement of the dispersion. The diameter of a conductive micro particle is not less than 1 nm nor more than 0.1 μm. If the diameter is larger than 0.1 μm, particles may clog the nozzle of a droplet discharging head to be described later. On the other hand, when the size is less than 1 nm, the volume ratio of a coating material to the conductive micro particle becomes large and the ratio of an organic material in the obtained film becomes excessively large.

A dispersion medium is not specifically limited if it can disperse the conductive micro particles and does not make particles aggregate. Examples of such dispersion medium are water; alcohol such as methanol, ethanol, propanol, and butanol; carbon hydride compounds such as n-heptane, n-octane, decane, dodecane, tetradecane, toluene, xylene, cymene, durren, inden, dipenten, tetrahydro naphthalene, decahydro naphthalene and cyclohexyl benzen; and eter compounds such as ethleneglycol dimethyl eter, ethleneglycol diethyl eter, ethleneglycol methyl ethyl eter, diethleneglycol dimethyl eter, diethleneglycol diethyl eter diethleneglycol methyl ethyl eter, 1,2-di methoxy ethane, bis(2-methoxy ethyl)eter, and p-dioxane; and polar compounds such as propylene carbonate, γ-butyrolactone, N-methyl-2-pyrrolidone, dimethyl formamide, dimethyl sulfoxide, and cyclohexanone. Water, alcohol, carbon hydride compounds and ether compounds among them are preferable in view of dispersion of micro particles, stable solution, and ease for applying to a droplet discharging method. In particular, water and carbon hydride compounds are further preferable as the dispersion medium.

The surface tension of the dispersion liquid including conductive micro particles is preferably in the range not less than 0.02 N/m nor more than 0.07 N/m. If the surface tension is less than 0.02 N/m, droplets are likely to veeringly fly when droplets are discharged by a droplet discharging method since the wettability of ink to the discharging nozzle surface increases. On the other hand, if the surface tension is more than 0.07 N/m, it becomes difficult to control the amount of discharging and timing of it since the configuration of meniscus becomes unstable at the nozzle edge. In order to control the surface tension, a small amount of fluorine, silicone, or nonion materials for controlling the surface tension may be added to a liquid material as well as avoiding a substantial decrease of the contact angle with the surface of the substrate. A nonion material for controlling the surface tension improves the wettability of ink to the substrate and the leveling property of the film, preventing the coated film from having fine uneven surfaces. The materials for controlling the surface tension may include organic compounds such as alcohol, ether, ester, and ketene if they are necessary.

The viscosity of the dispersion liquid is preferably not less than 1 mPa·s nor more than 50 mPa·s. If the viscosity of the liquid is less than 1 mPa·s, the periphery of the nozzle is easily contaminated with Rowed ink when a liquid material is discharged as droplets by a droplet discharging method. On the other hand, if the viscosity of the liquid is more than 50 mPa·s, the nozzle hole is easily clogged, making it difficult to smoothly discharge droplets.

Various materials such as glass, quartz glass, a silicon wafer, a plastic film, and a metal board can be used as the substrate on which a wiring pattern is formed. Substrates that use these materials and on which a semiconductor film, a metal film, a dielectric film, an organic film, and the like is formed as the underlying layer may also be used.

Here, an electrification control method, a pressure vibration method, an electromechanical conversion method, an electrothermal conversion method, and an electrostatic suction method are cited as discharging techniques of the droplet discharging method. The electrification control method is a technique in which a charge electrode applies a charge to a material and a deflecting electrode controls the flying direction of the material so that the material is discharged from a discharging nozzle. In the pressure vibration method, ultrahigh pressure of about 30 kg/cm² is applied to a material so that the material is discharged to the nozzle edge side. If no control voltage is applied to a material, the material moves straight to be discharged from the discharging nozzle. On the other hand, if a control voltage is applied, electrostatic repulsion occurs among particles of the material, and the material is scattered not to be discharged from the discharging nozzle. The electromechanical conversion method utilizes the property that a piezo element (piezoelectric element) deforms when receiving a pulsed electrical signal, By deformation of the piezo element, pressure is applied through a flexible member to a space where a material is contained, and as a result, the material is ejected from the space to be discharged from the discharging nozzle.

In the electrothermal conversion method, the material is rapidly vaporized to create bubbles by a heater provided in the space containing the material, and is ejected from the space by the pressure of the bubbles. In the electrostatic suction method, a small amount of pressure is applied to the inside of the space where the material is contained so as to form a meniscus of the material at the discharging nozzle, and in this state electrostatic suction is applied to draw out the material. Additionally, other techniques such as a method of utilizing changes in viscosity of a fluid depending on the electric field and a method of spraying droplets by a spark can be applied. The droplet discharging method has advantages in that it has little waste in material use and a desired amount of material can be accurately placed at a desired location. The mass of one droplet of liquid material (fluid) discharged by the droplet discharging method is, for example, 1 to 300 nanograms.

In this embodiment, a droplet discharging device (inkjet device) using a piezo element (piezoelectric element) of the electromechanical conversion method is used as a device for discharging droplets as described above.

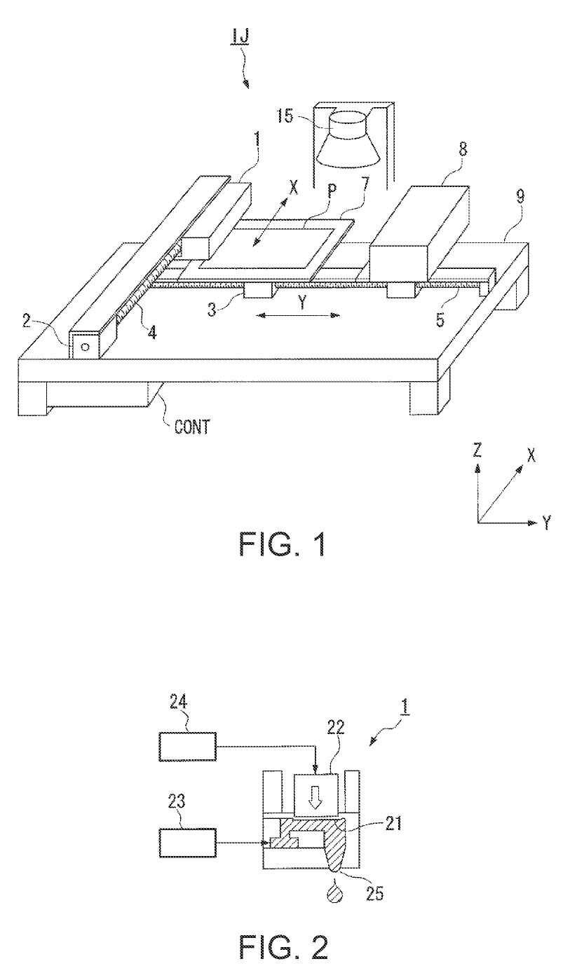

FIG. 1 is a perspective view illustrating a schematic structure of a droplet discharging device IJ.

The droplet discharging device IJ includes a droplet discharging head 1, a driving shaft for the X-axis direction 4, a guiding shaft for the Y-axis direction 5, a controller CONT, a stage 7, a cleaning mechanism 8, a base 9, and a heater 15.

The stage 7 supports a substrate P which receives a liquid material (ink for wiring pattern) from the droplet discharging device IJ, and includes a fixing mechanism (not shown in the figure) to fix the substrate P to the reference position.

The droplet discharging head 1 is provided with a plurality of discharging nozzles as a multiple-nozzle type and its longitudinal direction is coincided with the X-axis direction. The plurality of discharging nozzles spaced at regular intervals are provided on the undersurface of the droplet discharge head 1. Ink for wiring pattern containing the above-described conductive micro particles is discharged from the discharging nozzle of the droplet discharging head 1 to the substrate P supported by the stage 7.

A driving motor for the X-axis direction 2 is connected to the driving shaft for the X-axis direction 4. The driving motor for the X-axis direction 2 is a stepping motor or the like and rotates the driving shaft for the X-axis direction 4 when a drive signal in the X-axis direction is supplied from the controller CONT. When the driving shaft for the X-axis direction 4 is rotated, the droplet discharging head 1 is moved in the X-axis direction.

The guiding shaft for the Y-axis direction 5 is fixed not to move with respect to the base 9. The stage 7 is provided with a driving motor for the Y-axis direction 3. The driving motor for the Y-axis direction 3 is a stepping motor or the like that moves the stage 7 in the Y-axis direction when a drive signal in the Y-axis direction is supplied from the controller CONT.

The controller CONT supplies a voltage to the droplet discharging head 1 to control discharging of droplets. It also supplies a drive pulse signal to the driving motor for the X-axis direction 2 to control movement of the droplet discharging head 1 in the X-axis direction, and supplies a drive pulse signal to the driving motor for the Y-axis direction 3 to control movement of the stage 7 in the Y-axis direction.

The cleaning mechanism 8 cleans the droplet discharging head 1. The cleaning mechanism 8 is provided with a driving motor in the Y-axis direction (not shown). The cleaning mechanism is driven to move along the guiding shaft for the Y-axis direction 5 by the Y-axis direction driving motor. The movement of the cleaning mechanism 8 is also controlled by the controller CONT.

The heater 15 is used here as a means for heating treatment of the substrate P by lamp annealing and performs evaporation and drying of a solvent contained in a liquid material provided on the substrate P. Power on and off of the heater 15 is also controlled by the controller CONT.

The droplet discharging device IJ discharges droplets onto the substrate P from a plurality of discharging nozzles arranged in the X-axis direction on the undersurface of the droplet discharging head 1 while relatively scanning the droplet discharging head 1 and the stage 7 supporting the substrate P.

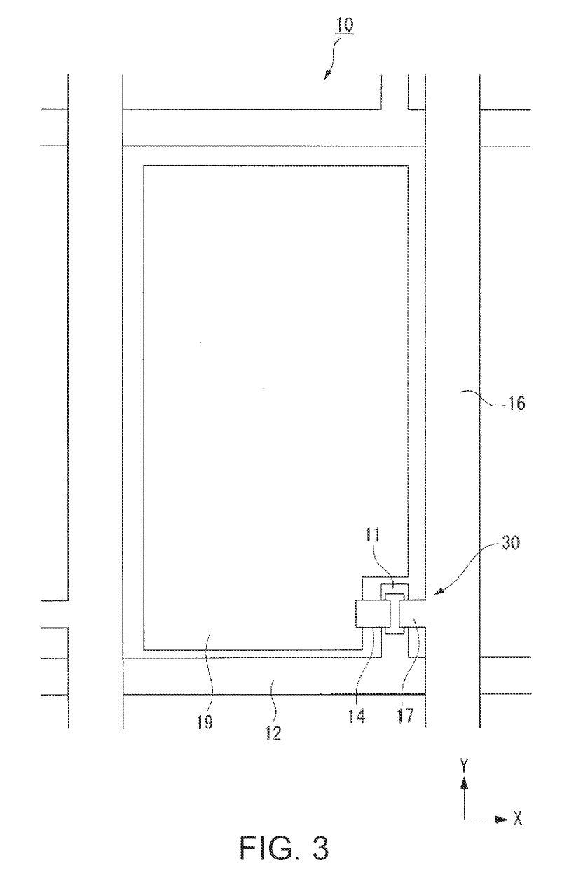

FIG. 2 is a diagram for explaining the principle of discharging a liquid material based on a piezo method.

In FIG. 2, a piezo element 22 is placed adjacent to a liquid chamber 21 storing a liquid material (ink for wiring pattern, functional liquid). A liquid material is supplied to the liquid chamber 21 through a liquid material supplying system 23 including a material tank that stores the liquid material. The piezo element 22 is coupled to a drive circuit 24, through which a voltage is applied to the piezo element 22 so as to deform the piezo element 22. The deformation of the piezo element 22 causes deformation of the liquid chamber 21, and thereby a liquid material is discharged from a discharging nozzle 25. In this case, the deformation amount of the piezo element 22 is controlled by varying the applied voltage, and its deformation velocity of the piezo element 22 is controlled by varying the frequency of the applied voltage. The droplet discharging based on a piezo method does not add heat to a material, and therefore has an advantage of having little effect on the composition of the material.

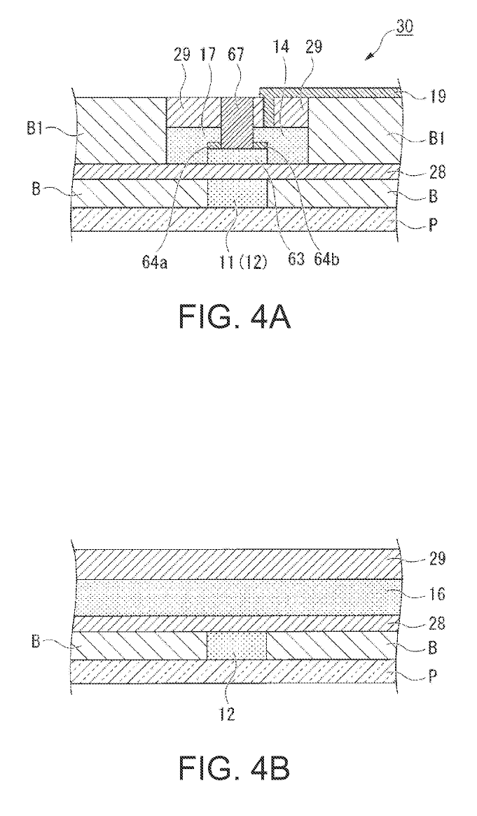

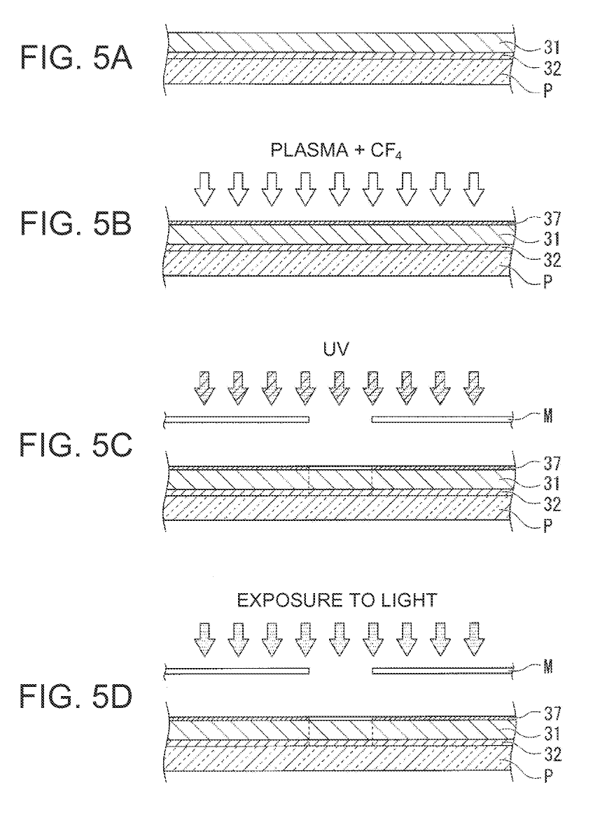

Next, a thin film transistor (TFT) that is an example of a semiconductor device manufactured by using a method of forming a wiring pattern of the embodiment will be described. FIG. 3 is a plan view showing a schematic structure of a portion including one TFT of a TFT array substrate. FIG. 4A is a sectional view of the TFT, and FIG. 4B is a sectional view of a portion where gate wiring and source wiring are coplanar and intersect each other.

As shown in FIG. 3, gate wiring 12, source wiring 16, a drain electrode 14, and a pixel electrode 19 electrically connected to the drain electrode 14 are provided on a TFT array substrate 10 having a TFT 30. The gate wiring 12 is formed so as to extend in the X-axis direction, and part thereof is formed so as to extend in the Y-axis direction. The part of the gate wiring 12 extending in the Y-axis direction is used as a gate electrode 11. The width of the gate electrode 11 is narrower than that of the gate wiring 12. The gate wiring 12 is formed by the method of forming a wiring pattern of the embodiment. Part of the source wiring 16, which extends in the Y-axis direction, is formed to be wider. The wider part of the source wiring 16 is used as a source electrode 17.

As shown in FIGS. 4A and 413, the gate wiring 12 and the gate electrode 11 are formed between banks B provided on the substrate P. The gate wiring 12, the gate electrode 11, and the banks B are covered with an insulating film 28. An active layer 63, which is a semiconductor layer, the source wiring 16, the source electrode 17, the drain electrode 14, and banks 131 are formed on the insulating film 28. The active layer 63 is provided at a position substantially opposite to the gate electrode 11, and part of the active layer 63 that is opposite to the gate electrode 11 is a channel region. Junction layers 64a and 64b are provided on the active layer 63. The source electrode 17 is jointed to the active layer 63 holding a junction layer 64a therebetween. On the other hand, the drain electrode 14 is jointed to the active layer 63 holding a junction layer 64b therebetween. The drain electrode and junction layer 64a and the drain electrode 14 and junction layer 64b are insulated from each other by using a bank 67 provided on the active layer 63. The gate wiring 12 is insulated from the source wiring 16 by the insulating film 28, and the gate electrode 11 is insulated from the source electrode 17 and drain electrode 14 by using the insulating film 28. The source wiring 16, the source electrode 17, and the drain electrode 14 are covered with the insulating film 29. A contact hole is formed in part of the insulating film 29 that covers the drain electrode 14, and the pixel electrode 19 connected through the contact hole to the drain electrode 14 is formed on the top surface of the insulating film 29.

Next, a process of forming a wiring pattern of the gate wiring of the TFT 30 using the method of forming a wiring pattern of the embodiment will be described.

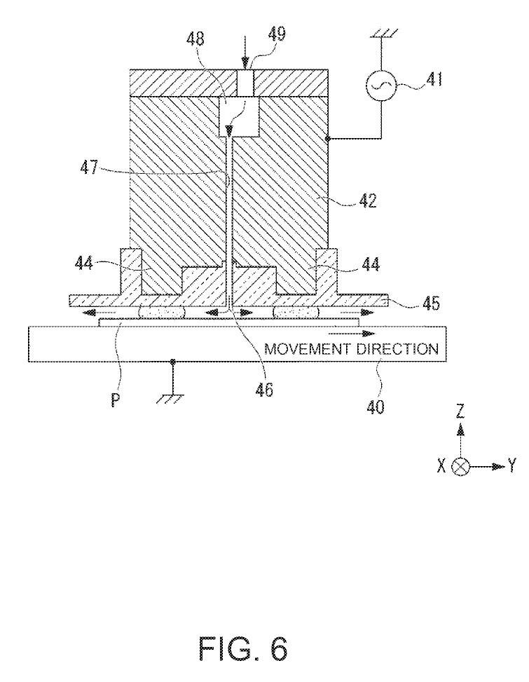

In the embodiment, a bank corresponding to the wiring pattern is formed on the glass substrate, as described above. Prior to this formation, a lyophilic treatment is performed for the substrate. The lyophilic treatment is performed so as to obtain a good wettability of the substrate P to the discharged ink when ink (functional liquid) is placed by discharging as described later. For example, as shown in FIG. 5A, a film with high lyophilic property (hydrophilic property) 32 such as TiO₂ is formed on the surface of the substrate P. Alternatively, hexamethyldisilazane (HMDS) in a steam state may be adhered onto the surface to be processed of the substrate P (HMDS processing) so as to form the film with high lyophilic property 32. The surface of the substrate P may also be made rough so as to exhibit lyophilic property.

When the lyophilic treatment has been performed as described above, a bank is formed on the substrate P.

A bank functions as a partitioning part, and can be formed by an arbitrary method such as a lithography method or a printing method. For example, if a lithography method is used, first, a photosensitive material that contains a resist liquid for forming a bank, namely any one of polysilazane, polysilane, and polysiloxane and either a photoacid generator or a photobase generator, and functions as a positive photo resist is applied onto the substrate P in accordance with a desired bank height by a predetermined method such as spin coating, spray coating, roll coating, die coating, or dip coating, thereby forming a bank film 31, as shown in FIG. 5A. In the embodiment, a polysilazane liquid is used as the photosensitive material.

Here, as the polysilazane liquid used for the material for forming a bank, a photosensitive polysilazane liquid mainly composed of polysilazane and particularly including polysilazane and a photoacid generator is preferably used. The photosensitive polysilazane liquid functions as a positive photo resist, which can be directly patterned through the process of exposure to light and the process of developing. A related art example JP-A-2002-72504 discloses exemplary photosensitive polysilazane. Further, JP-A-2002-72504 also discloses an exemplary photoacid generator included in the photosensitive polysilazane. In addition, regarding the photosensitive material such as a photosensitive polysilazane liquid, a material containing a photobase generator instead of a photoacid generator may be used.

If this polysilazane is, for example, polymethylsilazane as shown in the following formula (1), part of the polysilazane is hydrolyzed as shown in the following formula (2) or (3) by humidification as described later. Further, this hydrolyzed polysilazane becomes polymethylsiloxane [—(SiCH₃O_{1.5})n-] with condensation as shown in the following formulas (4) to (6) by heating at a temperature less than 400° C. In the following formulas (2) to (6), only basic element units (repeated units) are shown by simplifying chemical formulas in order to explain reaction mechanisms.

Polymethylsiloxane formed in this manner is mainly composed of polysiloxane and has a methyl group as its side chain. Therefore, polymethylsiloxane has high resistance against heating since its main component is inorganic. Thus, polymethylsiloxane is preferable as a bank material.
—(SiCH₃(NH)_{1.5})n- Formula (1)
SiCH₃(NH)_{1.5}+H₂O→SiCH₃(NH)(OH)+0.5NH₃ Formula (2)
SiCH₃(NH)_{1.5}+2H₂O→SiCH₃(NH)_{0.5}(OH)₂+NH₃ Formula (3)
SiCH₃(NH)(OH)+SiCH₃(NH)(OH)+H₂O→2SiCH₃O_{1.5}+2NH₃ Formula (4)
SiCH₃(NH)(OH)+SiCH₃(NH)_{0.5}(OH)₂→2SiCH₃O_{1.5}+1.5NH₃ Formula (5)
SiOH₃(NH)_{0.5}(OH)₂+SiCH₃(NH)_{0.5}(OH)₂→2SiCH₃O_{1.5}+NH₃+H₂O Formula (6)

Subsequently, the obtained bank film 31 is preliminarily baked at a temperature of 110° C. for about 3 minutes on a hot plate, for example.

Next, the surface property of the bank film 31 is modified into being lyophobic by the lyophobic treatment, as shown in FIG. 5B. Plasma processing (CF₄ plasma processing) using tetrafluoromethane as the processing gas is preferably adopted as the lyophobic treatment. The conditions for plasmatizing CF₄ gas are the plasma power: 50 to 1000 W, the amount of CF₄ gas: 50 to 100 mL/min, the speed of transferring a base relatively to a plasma discharging electrode: 0.5 to 1020 mm/sec and the base temperature: 70 to 90° C. The lyophobic treatment gas is not limited to tetrafluoromethane, and other fluoroacarbon gases and other types of gas such as SF₆ and SF₅CF₃ may be used as the lyophobic treatment gas.

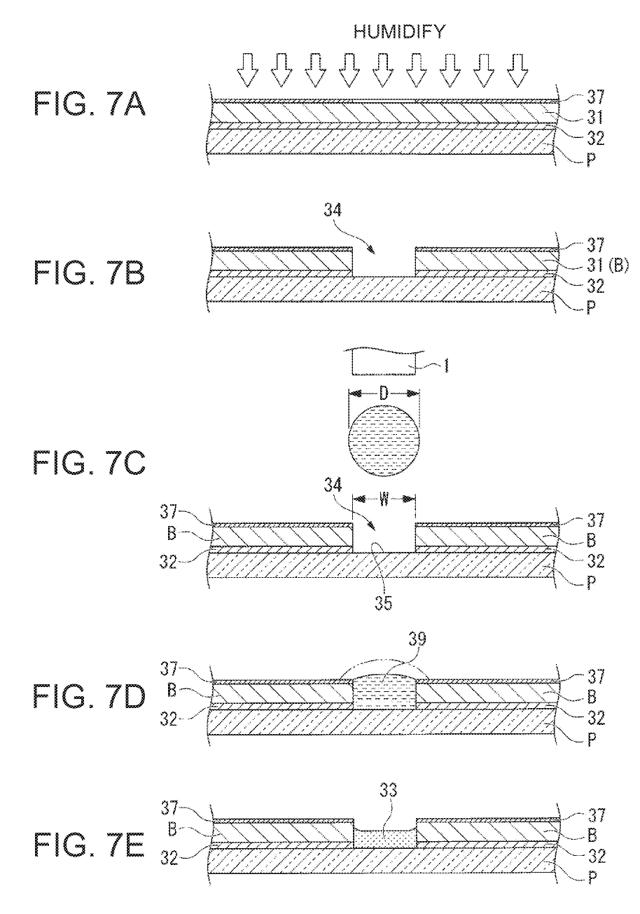

FIG. 6 is a schematic structure view showing an example of a plasma processing device used in CF₄ plasma processing. The plasma processing device shown in FIG. 6 includes an electrode 42 connected to an alternator 41 and a sample table 40, which is a ground electrode. The sample table 40 can move in the Y-axis direction while supporting the substrate P, which is a sample. On the undersurface of the electrode 42, two electric discharge sections 44, which extend in the X-axis direction orthogonal to the movement direction, are provided to protrude in parallel and a dielectric member 45 is provided to surround the electric discharge sections 44. The dielectric member 45 prevents the abnormal electric discharge of the electric discharge sections 44. The undersurface of the electrode 42 including the dielectric member 45 is substantially planar such that a slight space (discharge gap) is formed between the electric discharge sections 44 and dielectric member 45 and the substrate P. A gas spout 46 constituting part of a processing gas supply section having an elongated shape in the X-axis direction is provided at the center of the electrode 42. The gas spout 46 is connected through a gas passage 47 and an intermediate chamber 48 to a gas feed port 49.

A predetermined gas including the processing gas injected from the gas spout 46 is separated into two directions, forwards and backwards in the movement direction (Y-axis direction), and flows in the two directions in the space mentioned above and is exhausted from the front and back ends of the dielectric member to the outside. At the same time, a predetermined voltage is applied from the alternator 41 to the electrode 42 to cause gaseous discharge between the electric discharge sections 44 and the sample table 40. Excitation activate species of the predetermined gas are generated by plasma generated by the gaseous discharge, so that the entire surface of the bank film 31 formed on the substrate P passing through an area where the gaseous discharge occurs is continuously processed.

The predetermined gas is a mixture of tetrafluoromethane functioning as the processing gas and a rare gas such as helium (He) or argon (Ar) and an inactive gas such as nitrogen (N₂) for facilitating the start of discharge and stably maintaining the discharge under the pressure in the vicinity of atmospheric pressure.

As a result of such a lyophobic treatment, a fluorine group is introduced into a methyl group of polymethylsilazane constituting the bank film 31. High lyophobic property to the functional liquid is thereby provided to the surface of the bank film 31, forming a lyophobic layer 37 on the surface of the bank film 31, as shown in FIG. 5B. Regarding the level of lyophobic property of the lyophobic layer 37, the contact angle of the functional liquid is preferably 90 degrees or more. If the contact angle is less than 90 degrees, the functional liquid easily remains on the top surface of the obtained bank B.

As shown in FIG. 5C, UV rays are selectively applied to the bank film 31 using a mask M so as to reduce the lyophobic property of the lyophobic layer 87 in the irradiated portion. Here, the portion selectively irradiated with UV rays using the mask M corresponds to the portion where a wiring pattern is to be formed, and will be removed by the developing to be described later. As the UV rays for irradiation, UV rays in the short wavelength region having such wavelength as 172 nm, 185 nm, or 254 nm are preferably used. In the embodiment, excimer UV rays are selectively applied using the mask M. The fluorine group introduced by the lyophobic treatment as described above is removed by the UV radiation, so that the lyophobic property is lost or remarkably reduced. Therefore, the lyophobic property exhibited by the lyophobic layer 37 has little effect in the portion irradiated with the UV rays.

Subsequently, as shown in FIG. 5D, the bank film 31 is exposed to light using the above-mentioned mask M, without any changes. In addition, the portion selectively exposed to light using the mask M is removed by the later developing since the bank film 31 functions as a positive photo resist as described above. The light source for exposure is appropriately selected and used from a high pressure mercury lamp, a low pressure mercury lamp, a metal halide lamp, a xenon lamp, an excimer laser, X-rays, and electron beams, which are used for existing exposure of a photo resist, considering the composition and photosensitive characteristics of the above-described photosensitive polysilazane liquid. The amount of energy of irradiating light depends on the light source and the film thickness, but is usually 0.05 mJ/cm² or more, and desirably 0.1 mJ/cm² or more. There is no particular uppermost limit on the amount of energy, but it is impractical with regard to the processing time to set too much amount of energy. Thus the amount of energy is usually 10000 mJ/cm² or less. In the embodiment, the amount of energy is 40 mJ/cm². Exposure to light may be performed in an ambient (in the atmospheric air) or a nitrogen ambient, and an ambient having an enriched oxygen content may also be adopted in order to facilitate decomposition of polysilazane.

In the bank film 31 composed of photosensitive polysilazane containing a photoacid generator, acid is selectively generated particularly in its exposed portion by the above-described exposure to light, breaking Si—N bonding of polysilazane. Reacting with moisture in the ambient, part of the bank film 31 is hydrolyzed as shown in the above formula (2) or (3). Eventually, silanol (Si—OH) bonding is produced and polysilazane is decomposed.

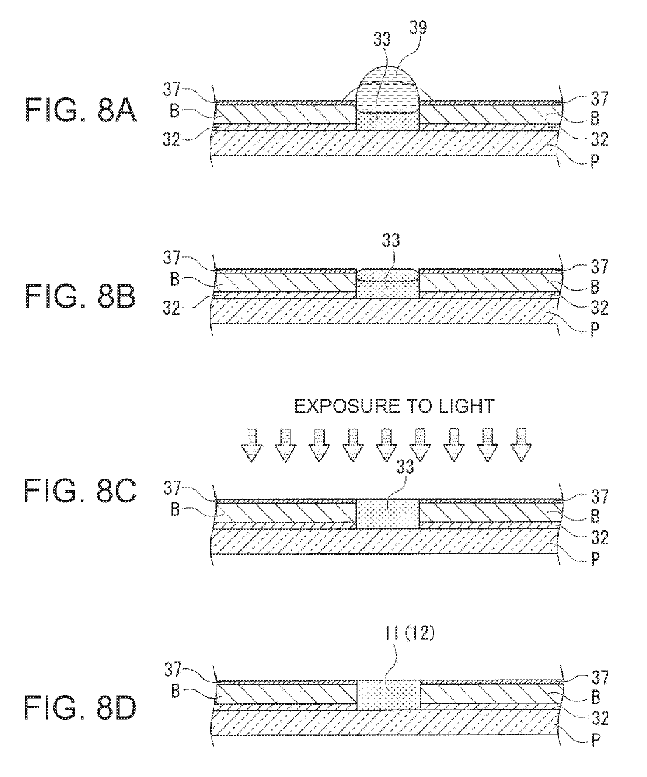

Next, in order to further facilitate silanol (Si—OH) bonding and decomposition of polysilazane, the bank film 31 after exposed to light is humidified for about 5 minutes in such environments as a temperature of 25° C. and a relative humidity of 85% as shown in FIG. 7A. By continuously supplying moisture into the bank film 31, acid that once contributed to breaking Si—N bonding of polysilazane functions repeatedly as a medium for breaking. Si—OH bonding occurs while the film is exposed to light. Thereafter, if the exposed film is humidified, Si—OH bonding of polysilazane is further facilitated.

The higher the humidity in the processing ambient of humidification is, the faster the speed of the Si—OH bonding can be. However, if the speed is too fast, there is a possibility of dew condensation on the surface of the film. In this view, the relative humidities of 90% or less are practical. Regarding such humidification, a gas containing moisture may be contacted with the bank film 81. Accordingly, the exposed substrate P may be placed in a humidification device, to which a gas containing moisture is continuously introduced. The exposed substrate P may also be placed and left for a predetermined period in a humidification device in which the humidity has already been controlled by introducing a gas containing moisture into the device beforehand.

Next, the bank film 31 after humidified is developed at a temperature of 28° C. for about 1 minute by a tetramethylammonium hydroxide (TMAH) liquid having a concentration of 2.38%, for example, so as to selectively remove the portion exposed to light. At this point, the surface of the portion to be removed can be easily wetted by a developer and the developer penetrates into the portion since the portion to be developed, namely the portion exposed to light, has the reduced lyophobic property by applying UV rays to the portion beforehand. Therefore, the portion to be removed is reliably removed, allowing the bank film 31 to have a desired bank shape as shown in FIG. 7B. Thus, banks B to partition the region for forming an intended wiring pattern (film pattern) are formed and at the same time a concave section 34 in a groove shape corresponding to the wiring pattern is formed. As the developer, alkaline developers other than TMAH, such as choline, sodium silicate, sodium hydroxide, and potassium hydroxide can be used.

Next, after the film is rinsed as needed, residue processing is performed for the residue between the obtained banks B. As the residue processing, hydrofluoric acid processing using a hydrofluoric acid solution to etch the residue, UV radiation applying UV rays, O₂ plasma processing using oxygen as the processing gas in the atmospheric ambient, and the like are used. The embodiment employs hydrofluoric acid processing that performs contact processing for around 20 seconds with a hydrofluoric acid solution having a concentration of 0.2%, for example. By the residue processing, a bottom 35 of the concave section 34 formed between the banks B is selectively etched since the banks B function as masks. A bank material and the like remaining in the bottom are thereby removed.

Next, droplets of the ink (functional liquid) for wiring pattern are discharged and placed onto the substrate P exposed in the concave section 34 between the banks B by using the droplet discharging device IJ mentioned above, as shown in FIG. 7C. In the embodiment, ink composed of organic silver compounds using organic silver compounds as the conductive material and using diethylene glycol diethyl ether as the dispersion medium is discharged as the ink for wiring pattern (functional liquid). The droplet discharging head 1 discharges droplets of ink towards the concave section 34 between the banks B to place the ink in the concave section 34. At this time, the region for forming a wiring pattern into which droplets are discharged (i.e., the concave section 34) is partitioned by the surrounding banks B, preventing the droplets from spreading beyond this region.

In the embodiment, the width of the concave section 34 between the banks B (here, the width of the opening of the concave section 34) is set to be substantially equal to the diameter D of the droplet of ink (functional liquid). The ambient of discharging droplets is preferably set at a temperature of 60° C. or less and a humidity of 80% or less. Such conditions allow stable droplet discharging without clogging of the discharging nozzle of the droplet discharging head 1.

When such a droplet is discharged from the droplet discharging head 1 and placed in the concave section 34, part of the droplet may be placed on the banks B as indicated by the chain double-dashed line in FIG. 7D. However, the part of ink placed on the banks B are repelled from the banks B since the property of the banks B is lyophobic. Further the part flows down into the concave section 34 by a capillary phenomenon, so that most of ink 39 slips into the concave section 34 as indicated by the full line in FIG. 7D.

The ink that is discharged in the concave section 34 or flows down from the banks B easily spreads in a wet state since the bottom 35 exposed in the concave section 34 and the inner side surfaces of the banks B do not constitute the lyophobic layer 37. As a result, the ink fills in the concave section 34 more evenly.

When the droplets have been discharged as described above, an intermediate drying is performed in order to remove the dispersion medium in the discharged ink (functional liquid) and secure the film thickness, if necessary. The drying can be performed usually by using a hot plate, an electric furnace, or the like that heats the substrate, for example, and in addition may be performed by lamp annealing. Light sources used for lamp annealing are not particularly limited, but infrared lamps, xenon lamps, YAG lasers, argon lasers, carbon dioxide gas lasers, excimer lasers such as XeF, XeCl, XeBr, KrF, KrCl, ArF, ArCl, and the like may be used as the light source. These light sources in the output range not less than 10 W nor more than 5000 W are generally used, but those in the range not less than 100 W nor more than 1000 W are sufficient for this embodiment. When the intermediate drying has ended, a circuit wiring film 33, which is a wiring film for forming a wiring pattern, is formed, as shown in FIG. 7E. The wiring pattern formed of the circuit wiring film 33 becomes the gate wiring 12 and the gate electrode 11 shown in FIGS. 3 and 4.

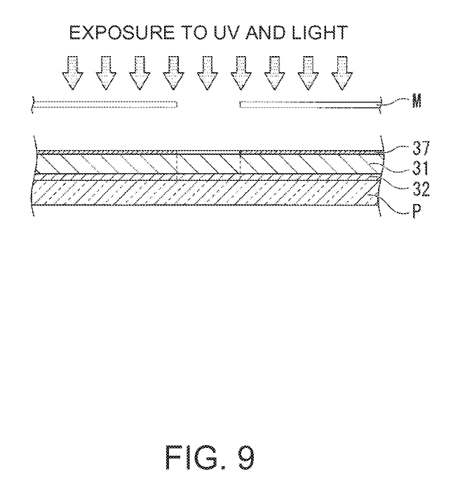

If the thickness of the circuit wiring film 33 does not reach the required film thickness by single functional liquid placement and intermediate drying, the functional liquid placement and intermediate drying described above are repeated. When a functional liquid is placed on the formed circuit wiring film 33 once again, the ink 39 that is not completely fallen into the concave section 34 repels to be raised on the concave section 34, as shown in FIG. 8A, since the property of the top surface of the bank B is lyophobic. The raised ink in and on the concave section 34 is dried by performing the intermediate drying once again. The droplets of ink are thereby stacked one atop the other as shown in FIG. 8B, forming the circuit wiring film 33 having a thick film thickness The number of repeating the functional liquid placement and intermediate drying is appropriately selected in consideration of the required film thickness and the thickness of the circuit wiring film 33 formed by single functional liquid placement and intermediate drying, so that the required film thickness can be obtained.

As shown in FIG. 5C, the entire surface at the bank B side of the substrate P is exposed to light. The conditions of exposure to light are the same as those in the process shown in FIG. 5D. By exposing the entire surface to light, the bank B, which has not been exposed to light, is exposed to light. As a result, part of polysilazane for forming the bank B is hydrolyzed, and finally silanol (Si—OH) bonding is produced and polysilazane is decomposed.

As shown in FIG. 8D, the wiring pattern formed by the intermediate drying is burned using a clean oven in the atmospheric air at a temperature of about 280 to 350° C. for about 300 minutes, for example. By this burning, the bank B that is made of polysilazane having a SiOH bond generated by humidification and exposure to light easily becomes (SiOSi) as shown in the above-mentioned chemical formulas (4) to (6), to be converted to a silica-based ceramic film in which few (or no) SiNH bonds exist, such as polymethylsiloxane. The bank B made of polymethylsiloxane (silica-based ceramic film) has high resistance against heating since the bank B is mainly composed of polysiloxane as described above, so that the bank B can sufficiently resist the process of burning the wiring pattern.

Through these above-mentioned processes, the dried film after the droplet discharging process, which is made of a functional liquid (wiring pattern), changes to a conductive film, namely the gate wiring 12 and the gate electrode 11 shown in FIGS. 3 and 4, wherein electrical contact among micro particles is secured.

In the method of forming a wiring pattern (film pattern) in the embodiment, and particularly in the method of forming the bank, for the bank film 31 to which a lyophobic treatment has been applied, the lyophobic property of a portion of the film to be removed by developing is reduced before developing by applying UV rays to the portion. Therefore, in developing, the surface of the portion to be removed can be easily wetted by a developer and the developer penetrates into the portion. The portion to be removed can reliably be removed by developing. Thus, this method secures good accuracy of patterning the bank B and can prevent a disadvantage of the residue remaining in the concave section 34.

In related art examples, the degree of the lyophobic property made in the lyophobic treatment must be controlled considering irregularity of developing in the later developing process. However, according to the embodiment, it is unnecessary to control the degree of the lyophobic property since the lyophobic property of the portion to be removed by developing is reduced by exposure to UV radiation. Hence, productivity can be improved by expanding the manufacturing margin.

Further, the mask M need neither be removed nor changed between the above-mentioned two processes, the process of reducing the lyophobic property and the process of exposure to light, since these processes are continuously performed using the same mask M. Therefore, the productivity can be improved.

A photosensitive polysilazane liquid containing a photoacid generator is used as a photo resist liquid for forming a bank in the embodiment, but the invention is not limited to this. For example, a polysilazane liquid, a polysilane liquid, and a polysiloxane liquid other than this liquid, and further commonly used photo resist materials (photo resist liquids) made of organic materials may be used.

The humidification facilitates Silanol (Si—OH) bonding and decomposition of polysilazane in the embodiment, but the invention is not limited to this. For example, the humidification may be omitted depending on the kind of the used polysilazane liquid.

Further, the exposure to UV radiation (process of UV irradiation) shown in FIG. 5C and the exposure to light (process of exposure to light) shown in FIG. 5D are continuously performed in this order in the above-described embodiment, but these processes may also be continuously performed in the reverse order. In this case, the productivity can also be improved since the processes are continuously performed using the same mask.

### Second Embodiment

Next, another embodiment in which the method of forming a film pattern according to one embodiment of the invention is applied to a method of forming a wiring pattern (film pattern) will be described.

This embodiment differs from the above embodiment in that the exposure to UV radiation (process of UV irradiation) shown in FIG. 5C and the exposure to light (process of exposure to light) shown in FIG. 5D are performed at the same time.

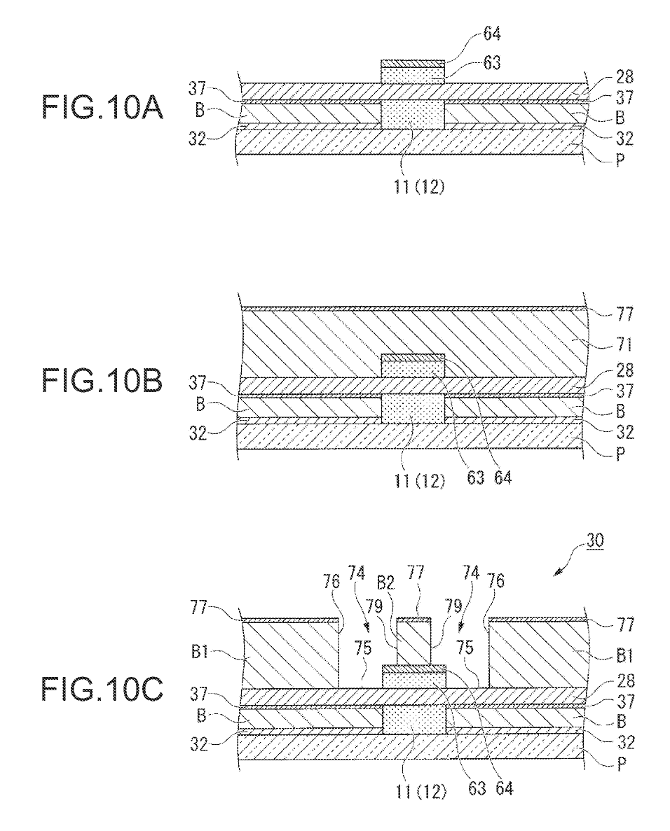

Namely, in the embodiment, a lyophobic treatment is applied to the surface of the bank film 31 to form the lyophobic layer 37 on the surface as shown in FIG. 5B, and thereafter the exposure to UV radiation and the exposure to light are performed at the same time using the single mask M as shown in FIG. 9. In simultaneous performing, a device having exposure light source for emitting light such as G line (254 nm), H line (365 nm), or I line (405 nm) and another light source for emitting UV rays in the short wavelength region having such wavelength as 172 nm, 185 nm, or 254 nm is prepared. The film is irradiated with the light and the UV rays (UV light) at the same time by using this light exposure device as shown in FIG. 9, so that the portion to be removed by developing is exposed to light and at the same time the lyophobic property of the surface of the lyophobic layer 37 is reduced.

Then, the bank B as well as the gate wiring 12 and gate electrode 11 that are patterned with good accuracy because of the bank B can be formed by the same processes as in the above embodiment. In the embodiment the process of humidifying shown in FIG. 7A may be omitted, and instead the conditions for exposing the entire surface of the film to light shown in FIG. 8C may be changed. For example, the amount of energy may be increased to be 1500 mJ/cm².

In this method, the process of reducing the lyophobic property and the process of exposure to light are performed at the same time using the single mask M. The mask M, of course, need not be removed or changed between the processes. Further, the processing time can be shortened by reducing two processes to one process. Thus, the productivity can be largely improved.

In this method, developing can reliably remove the portion to be removed. Therefore, the method secures good accuracy of patterning the bank B and can prevent a disadvantage of the residue remaining in the concave section 34. Further, it is unnecessary to control the degree of the lyophobic property. Hence, the manufacturing margin expands, enabling productivity to be improved.

The above-described embodiment is explained taking an example in which the method of forming a film pattern according to one embodiment of the invention is applied to a method of forming a wiring pattern. However, the method of forming a film pattern according to one embodiment of the invention may also be applied, for example, to manufacturing a color filter other than forming a wiring pattern.

### Third Embodiment

Next, another embodiment according to the method of forming a film pattern of the embodiment of the invention will be described. In the embodiment, circuit wiring (wiring pattern) is formed on the wiring pattern (film pattern) formed in the first or second embodiment. A droplet discharging method and a droplet discharging device, and further a semiconductor device manufactured in this embodiment are basically identical to those in the first embodiment.

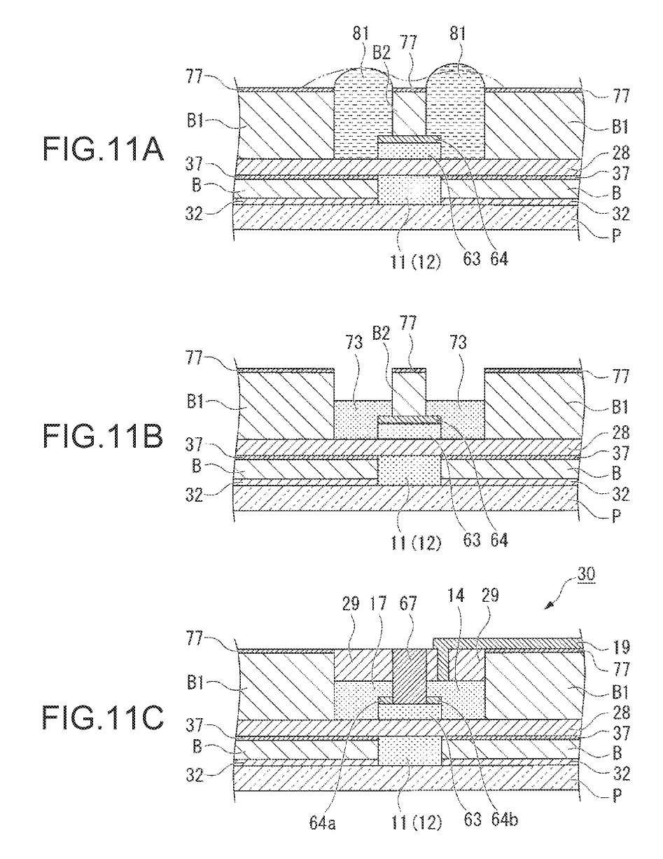

In the embodiment, first, a gate insulating film (the insulating film 28), an active layer 63, which is a semiconductor film, and a junction layer 64 are continuously formed on the gate wiring 12 (the gate electrode 11) as the wiring pattern formed in the first and second embodiments by a plasama CVD method, as shown in FIG. 10A. A silicon nitride film as the insulating film 28, an amorphous silicon film as the active layer 63, and n+ type silicon film as the junction layer 64 are formed by changing the gas as raw material and plasma conditions. The CVD method requires heat history at a temperature of 300 to 350° C. However, the above-described bank B has high heat resistance since it is made of an inorganic material mainly composed of polysiloxane. Hence, an issue regarding heat resistance can be avoided.

Next, a material for forming a bank is provided to cover the insulating film 28, the active layer 63, and the junction layer 64, forming a bank film 71 as shown in FIG. 10B. The bank film 71 is not specifically limited. The above-mentioned photosensitive polysilazane liquid is used in the embodiment.

Subsequently, the obtained bank film 71 is preliminarily baked at a temperature of 110° C. for about 3 minutes on a hot plate, for example. Thereafter, a lyophobic treatment is performed for the bank film 71 similarly to the first embodiment so as to form a lyophobic layer 77 on the surface of the bank film 71.

Next, in order to pattern the bank film 71, the exposure to UV radiation (process of UV irradiation) shown in FIG. 5C and the exposure to light (process of exposure to light) shown in FIG. 5D are continuously performed in the same manner as in the first embodiment, or the exposure to UV radiation and the exposure to light are performed at the same time as shown in FIG. 9 in the same manner as in the second embodiment. In these cases, a desired portion is to be selectively exposed to light and UV radiation using the same mask.

After humidified as necessary, the bank film 71 is developed to be the bank B1 and a bank B2 in desired bank shapes as shown in FIG. 10C, and further a concave section 74 in a groove shape surrounded by the banks B1 and B2 is formed. Here, the concave section 74 exposes the insulating film 28 at its bottom and further exposes part of the active layer 63 and part of the junction layer 64. At this point, the portion to be developed, namely the portion exposed to light, has the reduced lyophobic property since the portion has been exposed to UV radiation beforehand. Therefore, the portion to be removed by developing can be easily wetted by a developer and the developer penetrates into the portion, in the same manner as in the above-described embodiment Thus, the portion to be removed can reliably be removed by developing. The banks B1 and B2 in desired bank shapes can thereby be formed as shown in FIG. 10C.

Next, after the film is rinsed as needed, residue processing is performed for the residue between the obtained banks B1 and B2. As the residue processing, hydrofluoric acid processing using a hydrofluoric acid solution to etch the residue, UV radiation applying UV rays, O₂ plasma processing using oxygen as the processing gas in the atmospheric ambient, and the like are used.

Next, similarly to the processes shown in FIGS. 7C to 8B in the first embodiment, droplets of ink for forming a wiring pattern 81 are discharged and placed between the banks B1 and B2, as shown in FIG. 11A. The same ink as used for forming the gate wiring 12 and the gate electrode 11, for example, is used as the ink for forming a wiring pattern.

Next, the entire surface of the film is exposed to light and the film is burned as shown in FIGS. 8C and 8D in the first embodiment. The banks B1 and B2 are thereby mainly composed of polysiloxane as described above. At the same time, a circuit wiring film 73, which is a wiring film for forming a wiring pattern, as shown in FIG. 11D is formed. In the embodiment, the wiring pattern formed in the circuit wiring film 73 constitutes the source wiring 16, the source electrode 17, and the drain electrode 14 shown in FIGS. 3 and 4.

Next, the bank B2 is removed, and further the junction layer 64 is etched to be divided into the junction layer 64a joined to the source electrode 17 and the junction layer 64b joined to the drain electrode 14, as shown in FIG. 11C. The bank 67 insulating the source electrode 17 from the drain electrode 14 is formed in the portion where the bank B2 has been removed and the portion where the junction layer 64 is removed by etching. The insulating film 29 is placed so as to fill in the concave section 74 in which the source electrode 17 and the drain electrode 14 are placed. Through these processes, the flat top surface consisting of the bank B1, the bank 67, and the insulating film 29 is formed. The bank 67 and the insulating film 29 may be formed of the same material and the insulating film 29 may be placed so as to fill in the concave section 74, insulating the source electrode 17 from the drain electrode 14. Before the bank film 71 is formed, the junction layer 64 may be etched to be divided into the junction layer 64a jointed to the source electrode 17 and the junction layer 64b jointed to the drain electrode 14.

Thereafter, a contact hole is formed in a portion covering the drain electrode 14 of the insulating film 29 placed to fill in the concave section 74, and the patterned pixel electrode (ITO) 19 is formed on the top surface such that the drain electrode 14 is connected to the pixel electrode 19 through the contact hole.

The gate electrode 11 and the gate wiring 12 are formed as described in the first embodiment, and the source electrode 17 and the drain electrode 14 are formed as described in the embodiment. Therefore, the TFT 30 as a semiconductor device can be formed, and further the TFT array substrate 10 having many TFTs 30 can be formed.

In this method of manufacturing the TFT 30 (semiconductor device), a wiring pattern (film pattern) has good accuracy because it is formed based on the above-mentioned banks B, B1, and B2 that are patterned with good accuracy. This secures good transistor characteristics obtained by the wiring pattern. The productivity of the TFT 30 is improved since the productivity of the banks B, B1, and B2, and film patterns (wiring patterns) using the banks B, B1, and B2 is improved.

### Fourth Embodiment

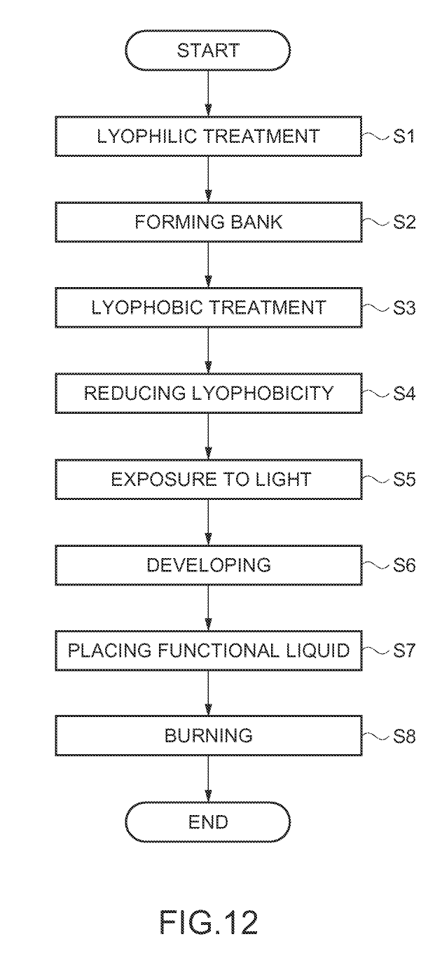

Next, another embodiment in which the method of forming a film pattern according to one embodiment of the invention is applied to a wiring pattern (film pattern) will be described with reference to FIGS. 5 and 7, and a flow chart of FIG. 12.

FIG. 5 is a schematic view for explaining a method of forming a bank. FIG. 7 is a schematic view for explaining a method of forming a wiring pattern. FIG. 12 is a flow chart illustrating the method of forming a wiring pattern.

The embodiment differs from the first embodiment in the material for forming a bank and processes for forming a bank.

Regarding the material for forming a bank, a photosensitive polysilazane liquid composed of a photo resist liquid serving as a liquid for forming a bank with polysilazane and a photoacid generator, which are inorganic materials, is adopted in the first embodiment, a photosensitive olefin resin liquid composed of a photo resist liquid with an olefin resin liquid, which is an organic material, and a photoacid generator is adopted in the embodiment.

Regarding the processes for forming a bank, the process of humidification shown in FIG. 7A, which is performed after the process of exposure to light using a mask, and the process of exposing the entire surface of the film to light shown in FIG. 8C, which is performed before the burning process, are omitted.

Next, the method of forming a film pattern will be described in the order of manufacturing processes including the method of forming a bank with reference to the flow chart of FIG. 12.

In FIG. 12, step S1 corresponds to a lyophilic treatment for forming a film with high lyophilic property 32 on the substrate P. Next, the method proceeds to step S2. Step S2 corresponds to forming a bank. Namely, a material liquid for forming a bank is applied and dried so as to form the bank film 31. Next, the method proceeds to step S3. Step S3 corresponds to a lyophobic treatment for modifying the property of the top surface of the bank film 31 into being lyophobic. Next, the method proceeds to step S4. The step S4 corresponds to reducing lyophobicity (lyophobic property) in the region from which the bank film 31 is removed. Next, the method proceeds to step S5. The step S5 corresponds to exposure to light for selectively exposing the region to be removed of the bank film 31 by using a mask. Next, the method proceeds to step S6. The step S6 corresponds to developing for selectively removing the exposed portion of the bank film 31 functioning as a positive photo resist. Next, the method proceeds to step S7. The step S7 corresponds to placing a functional liquid for applying wiring pattern ink. Next, the method proceeds to step S8. Step S8 corresponds to burning the bank film 31 and ink for wiring pattern. A wiring pattern is manufactured through these steps.

The manufacturing method will be described in detail referring to FIGS. 5 and 7 and corresponding to the steps shown in FIG. 12.

FIG. 5A is a view corresponding to lyophilic treatment in step S1 and forming a bank of step S2. A TiO₂ film with high lyophilic property 32 is formed on the substrate P, as shown in FIG. 5A (step S1). Next, a photosensitive olefin resin liquid including an olefin resin liquid, which is an organic material, is applied onto the film 32 as a photo resist liquid for forming a bank by a spin coating method, and the applied liquid is preliminarily baked at a temperature of 100° C. for about 2 minutes on a hot plate, forming the bank film 31 (step S2). As a result, the film with high lyophilic property 32 and the bank film 31 are stacked on the substrate P.

FIG. 6B is a view corresponding to a lyophobic treatment in step S3. The lyophobic treatment is performed for the top surface of the bank film 31 to modify the property of the surface into being lyophobic property, forming the lyophobic layer 37, as shown in FIG. 5B (step S8). Plasma processing (CF₄ plasma processing) using tetrafluoromethane as the lyophobic treatment gas is adopted as the lyophobic treatment. The conditions for plasmatizing CF₄ gas are the plasma power: about 400 W, the amount of CF₄ gas 50 to 100 mL/min, the speed of transferring a base relatively to a plasma discharging electrode: 10 to 20 mm/sec and the base temperature: 70 to 90° C. As the processing gas, other fluoroacarbon gases and other types of gas such as SF₆ and SF₅CF₃ may be used instead of tetrafluoromethane.

FIG. 5C is a view corresponding to reducing lyophobicity (lyophobic property) in step S4. The lyophobic layer 37 disposed on the surface of the bank film 31 is selectively irradiated with UV rays by using the mask M, as shown in FIG. 5C, to reduce the lyophobic property of the irradiated portion (step S4). Excimer UV light having a wavelength of 172 nm, for example, is adopted as the UV light for the treatment. The lyophobic property of lyophobic layer 37 has little effect in the portion irradiated with the UV rays.

FIG. 5D is a view corresponding to exposure to light in step S5. The bank film 31 is exposed to light by using a mask used in step S4, as shown in FIG. 5D. In the embodiment, the light source is a xenon lamp and the amount of energy of irradiating light is about 40 mJ/cm². Steps S4 and S5 may be continuously performed by using the same mask M, or may be performed at the same time by using the same device as used in the second embodiment.

FIG. 7B is a view corresponding to developing in step S6. The exposed substrate P is developed and the exposed portion is selectively removed, as shown in FIG. 7B. Developing is performed at a temperature of 28° C. for about 4.5 minutes using a TMAH liquid having a concentration of 2.38%, for example. As a result, the concave section 34 is formed between the banks B. The developer is not repelled in the portion exposed to light of the bank film 31 since the lyophobic property of the lyophobic layer 37 has little effect in the portion developed due to reducing the lyophobic property in step S4. Therefore the portion developed is reliably removed.

FIGS. 7C and 7D are views corresponding to placing a functional liquid in step S7. Droplets of ink for wiring pattern are discharged in the concave section 34 from the droplet discharging head 1, as shown in FIG. 7C (step S7). As a result, the ink 39 is applied in the concave section 34, as shown in FIG. 7D. The ink 39 is prevented from spreading from the concave section 34 onto the lyophobic layer 37 since the lyophobic layer 37 of the surface of the bank B has lyophobic property.

FIG. 7E is a view corresponding to burning in step S8. The ink 39 applied to the concave section 34 is burned to change to the circuit wiring film 33, as shown in FIG. 7E. The burning is performed using a clean oven in a nitrogen ambient at a temperature of about 200° C. for about 60 minutes, for example.

Through these above-mentioned processes, the ink for wiring pattern is burned, forming the circuit wiring film 33, which is a conductive film in which electrical contact among micro particles is secured.

As described above, the embodiment has the following effects in addition to the effects in the first embodiment.

(1) According to the embodiment, a solution containing an organic material is adopted as the photo resist liquid serving as the material for forming a bank. When CF₄ plasma processing is performed for an organic material, the doping amount of carbon tetrafluoride can be large compared to CF₄ plasma processing performed for an inorganic material. Therefore, the lyophobic layer 37 with high lyophobic property can be obtained by adoption of a solution containing an organic material as the photo resist liquid compared to adoption of a solution containing an inorganic material. When the ink 39 is discharged into the concave section 34, part of the droplet of the ink 39 protrudes from the concave section 34 to be placed on the lyophobic layer 37. At this point, the ink 39 moves to the concave section 34 due to the surface tension of the ink 39. In the movement of the ink 39 to the concave section 34, the residue of the ink 39 is unlikely to remain on the surface of the lyophobic layer 37 since the lyophobic layer 37 has high lyophobic property. As a result, the manufacturing method of the embodiment is a wiring manufacturing method capable of reducing the residue of the wiring pattern ink made on the bank B.

(2) According to the embodiment, a solution containing an organic material is adopted as the photo resist liquid serving as the material for forming a bank. The lyophobic layer 37 with high lyophobic property can be obtained by adoption of a solution containing an organic material as the photo resist liquid compared to adoption of a solution containing an inorganic material. With high lyophobic property of the lyophobic layer 37, when the ink 39 applied to the concave section 34 is not completely fallen into the concave section 34, the ink does not move to the surface of the lyophobic layer 37 but is raised. Therefore, a large amount of the ink 39 can be applied compared to the lyophobic layer 37 having low lyophobic property. With low lyophobic property of the lyophobic layer 37, a large amount of the ink 39 cannot be applied at the same time. Therefore, if a thick film is formed in the concave section 34, it is necessary to increase the number of repeating the process of placing a functional liquid and the process of intermediate drying. On the other hand, with high lyophobic property of the lyophobic layer 37, a large amount of the ink 39 can be applied at the same time. Therefore, the number of repeating the process of placing a functional liquid and the process of intermediate drying can be reduced. Thus, adoption of a solution containing an organic material as the photo resist liquid can lead to forming high thickness of the circuit wiring film 33 with improved productivity, compared to adoption of a solution containing an inorganic material.

(3) According to the embodiment, a solution containing an organic material is adopted as the photo resist liquid serving as the material for forming a bank. If a solution containing an inorganic material as the photo resist liquid serving as a material for forming a bank is adopted, the thickness of the photo resist layer must be 1 to 2 μm or less since a thick photo resist film causes a crack to occur in the photo resist film during the burning process. If a solution containing an organic material as the photo resist liquid serving as the material for forming a bank, the thickness of the photo resist layer can be increased up to about 5 to 8 μm since a thick photo resist film is unlikely to cause a crack.

A photosensitive olefin resin liquid containing a photoacid generator is used as the photo resist liquid serving as the material for forming a bank in the embodiment, but the invention is not limited to this. Insulating organic materials that are acceptable for a lyophobic treatment using plasma processing and have excellent adhesion appropriate for patterning by a method such as a lithography method or a printing method may be used. For example, high-polymer materials such as acrylic resins, polyimide resins, phenol resins, and melanin resins may be adopted.

The material for forming a bank contains a photoacid generator in order to gain a photosensitive function, but may contain a photobase generator instead, bringing the same effect.

### Fifth Embodiment

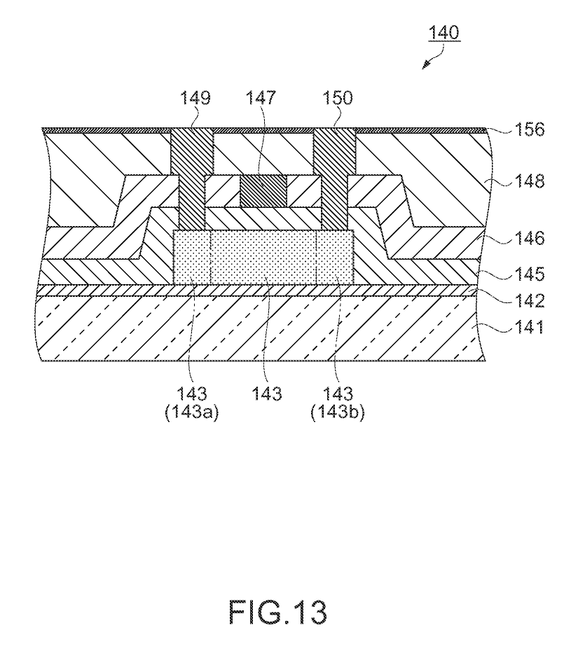

Next, a thin film transistor with a coplanar structure using a method of forming a film pattern according to one embodiment of the invention will be described with reference to FIGS. 13 to 17.

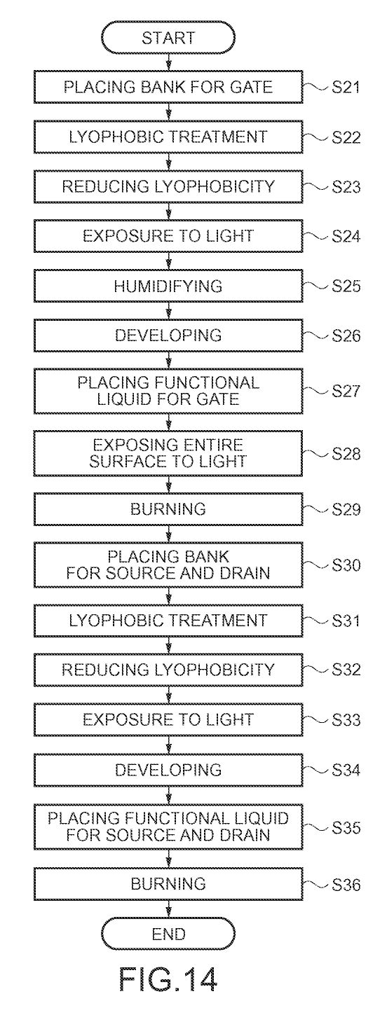

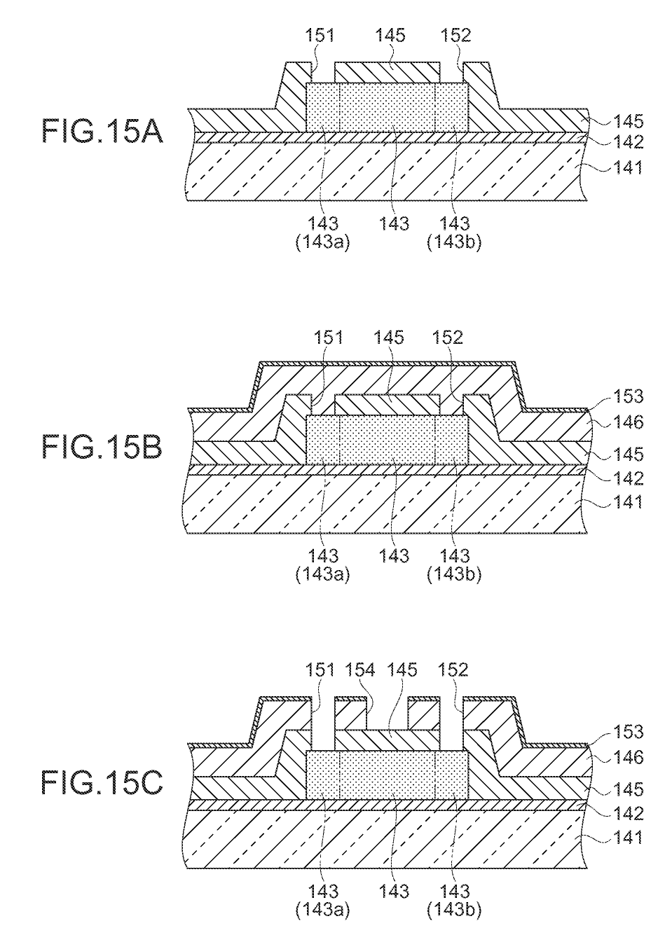

FIG. 13 is a schematic sectional view showing a main part of a TFT. FIG. 14 is a flow chart of processes of manufacturing the TFT. FIGS. 15A to 17C are schematic views for explaining a method of manufacturing the TFT.

As shown in FIG. 13, a TFT 140 as a transistor having a coplanar structure includes a substrate 141 made of glass. The top surface of the substrate 141 is covered with an underlying layer 142 made of oxide silicon. A polysilicon layer 143 is formed on the underlying layer 142, and N regions 143a and 143b doped with phosphorus are formed at the both sides of the polysilicon layer 143. An insulating layer 145 is formed on the top surfaces of the underlying layer 142 and the polysilicon layer 143, and a bank for gate 146 is formed on the top surface of the insulating layer 145. A gate electrode 147 is formed to be surrounded by the bank for gate 146 on the top surface of the portion of the insulating layer 145, which corresponds to the top surface of the part other than the N regions 143a and 143b of the polysilicon layer 143. A bank for source and drain 148 is formed on the top surfaces of the gate electrode 147 and the bank for gate 146. Further, a lyophobic layer 156 is formed on the top surface of a bank for source and drain 148.

A contact hole passing through the insulating layer 145, the bank for gate 146, and the bank for source and drain 148 is formed on the top surfaces of the N regions 143a and 143b of the polysilicon layer 143. A source electrode 149 electrically connectable with the N region 143a and a drain electrode 150 electrically connectable with the N region 143b are placed. When a voltage is applied between the drain electrode 150 and the source electrode 149 and a voltage is applied between the gate electrode 147 and the source electrode 149, a current flows from the drain electrode 150 to the source electrode 149, making the TFT 140 operate as a TFT with a switch function.

Next, a method of forming a gate electrode, a source electrode, and a drain electrode will be described with reference to a flow chart of FIG. 14. The underlying layer 142, the polysilicon layer 143, and the insulating layer 145 are formed on the substrate 141 by a known manufacturing method, and explanation of the forming is omitted.

In FIG. 14, step S21 corresponds to placing a bank for gate. Specifically, a material liquid of the bank for gate 146 is applied onto the layer 145. Next, the method proceeds to step S22. Step S22 corresponds to a lyophobic treatment, which modifies the property of the top surface of the bank for gate 146 into being lyophobic. Next, the method proceeds to step S23. Step S23 corresponds to reducing lyophobicity (lyophobic property). Specifically, lyophobic property of the film formed on the top surface of the bank for gate 146 is selectively and partially removed. Next, the method proceeds to step S25. Step S25 corresponds to humidifying. Specifically, the bank for gate 146 is humidified to facilitate its chemical reaction. Next, the method proceeds to step S26. Step S26 corresponds to developing to remove the portion exposed to light of the bank for gate 146. Next, the method proceeds to step S27. Step S27 corresponds to placing a functional liquid for gate. Specifically, a wiring material of the gate electrode is applied. Next, the method proceeds to step S28. Step S28 corresponds to exposing the entire surface to light for facilitating chemical reaction of the bank for gate 146. Next, the method proceeds to step S29. Step S29 corresponds to burning the bank for gate 146 and the gate electrode 147. Next, the method proceeds to step S30. Step S30 corresponds to placing a bank for source and drain. Specifically, a material liquid of the bank for source and drain 148 is applied onto the bank for gate 146. Next, the method proceeds to step S31. Step S31 corresponds to a lyophobic treatment which modifies the property of the top surface of the bank for source and drain 148 into being lyophobic. Next, the method proceeds to step S32. Step S32 corresponds to reducing lyophobicity (lyophobic property). Specifically, lyophobic property of the film formed on the top surface of the bank for source and drain 148 is selectively and partially removed. Next, the method proceeds to step S33. Step S33 corresponds to exposure to light. Specifically, the bank for source and drain 148 is selectively exposed to light using a mask. Next, the method proceeds to step S34. Step S34 corresponds to developing for removing the portion exposed to light of the bank for source and drain 148. Next, the method proceeds to step S35. Step S35 corresponds to placing a functional liquid for source and drain. Specifically, a wiring material of the source electrode and a wiring material of the drain electrode are applied. Next, the method proceeds to step S36. Step S36 corresponds to burning. Specifically, the bank for source and drain 148, the source electrode 149, and the drain electrode 150 are burned.

Next, the manufacturing method will be described in detail referring to FIGS. 15A to 17C and corresponding to the steps shown in FIG. 14.

FIGS. 15A and 15B are views corresponding to placing a bank for gate in step S21 and a lyophobic treatment in step S22. As shown in FIG. 15A, the underlying layer 142 is formed on the substrate 141, and the polysilicon layer 143 and the insulating layer 145 are placed on the top surface of the underlying layer 142. Portions of the insulating layer 145 on the top surface of the N regions 143a and 143b of the polysilicon layer 143 are removed to form concave sections 151 and 152. In the process of placing a bank for gate in step S21, a material of the bank for gate is applied onto the insulating layer 145 of the substrate 141 by a spin coating method, and the applied material is preliminarily baked at a temperature of 110° C. for about 3 minutes on a hot plate, for example. As a result, the bank for gate 146 is formed as shown in FIG. 15B. Photosensitive polysilazane is adopted as the bank material for gate similarly to the first embodiment.

The lyophobic treatment is performed for the top surface of bank for gate by using CF₄ plasma processing. The conditions for plasmatizing CF₄ gas are the plasma power: about 400 W, the amount of carbon tetrafluoride gas: 50 to 100 mL/min, the speed of transferring a base relatively to a plasma discharging electrode: 5 to 10 mm/sec and the base temperature: 70 to 90° C. As a result, a lyophobic layer 153 is formed as shown in FIG. 15B.

FIG. 15C is a view corresponding to reducing lyophobic property in step S23, exposure to light in step S24, humidifying in step S25, and developing in step S26.

In step S23, the lyophobic layer 153 is partially irradiated with excimer UV light having a wavelength of 172 nm by using a mask, for example. The fluorine group is removed from the portion of the lyophobic layer 153 irradiated with UV light, so that the lyophobic property does not function. Next, in step S24, the bank for gate 146 is exposed to light by using the same mask as used in step S23. A xenon lamp is used for exposure to light. As the conditions of exposure to light, the amount of energy of irradiating light is about 40 mJ/cm². In addition, reducing lyophobic property and exposure to light may be performed at the same time by using the same device as used in the second embodiment.

In step 825, humidifying is performed. The conditions for this humidification are, for example, the temperatures 25° C., the relative humidity: 85%, and humidifying time: about 5 minutes, Developing is performed in step S26. For example, the film is immersed in a TMAH liquid having a concentration of 2.38% used as the developer for about 1 minute at a liquid temperature of 18° C. After developed, the film is rinsed with pure water. As a result, a concave section 154 is formed in the bank for gate 146 on the top surface of the insulating layer 145 corresponding to the center of the top surface of the polysilicon layer 143, as shown in FIG. 15C. The bank material for gate is removed in the concave sections 151 and 152 to form the concave sections 151 and 152 passing through the surface of the bank for gate 146 to the polysilicon layer 143.

FIG. 16A is a view corresponding to placing a functional liquid for gate in step S27. In step S27, ink for gate wiring pattern 155 (functional liquid) is discharged and applied into the concave section 154 of the bank for gate 146 by using the droplet discharging device IJ. As the ink for gate wiring pattern 155 (functional liquid), ink composed of an organic silver compound using diethylene glycol diethylene ether as the dispersion medium is adopted. As a result, the ink for gate wiring pattern 155 is applied to the concave section 154 of the bank for gate 146 as shown in FIG. 16A.

FIG. 16B is a view corresponding to exposing the entire surface to light in step S28 and burning in step S29. In step S28, the entire surface of the bank for gate 146 is exposed to light. A xenon lamp is used for exposure to light. As the conditions of exposure to light, and the amount of energy of irradiating light is about 40 mJ/cm². In step S29, the bank for gate 146 and the ink for gate wiring pattern 155 are burned using a clean oven in an air ambient. The burning conditions are a temperature of 300° C. and the burning time pf 60 minutes. for example. As a result, the bank for gate 146 and the gate electrode 147 are burned to be formed, as shown in FIG. 16B. The fluorine group is removed from the lyophobic layer 153 by heating, so that the lyophobic property does not function. The lyophobic layer 153 disappears.

FIG. 16C is a view corresponding to placing a bank for source and drain in step S30 and a lyophobic treatment in step S31. In step S30, a material of the bank for source and drain is applied by spin coating, and the applied material is preliminarily baked at a temperature of 100° C. for about 2 minutes on a hot plate, forming the bank for source and drain 148. A photosensitive olefin resin liquid containing an organic olefin resin and a photoacid generator is adopted as the material of the bank for source and drain in the embodiment. Next, in step S31, the property of the top surface of the bank for source and drain 148 is modified into being lyophobic by CF₄ plasma processing. The conditions for plasmatizing CF₄ gas are the plasma power: about 400 W, the amount of carbon tetrafluoride gas: 50 to 100 mL/min, the speed of transferring a base relatively to a plasma discharging electrode 10 to 20 mm/sec and the base temperature: 70 to 90° C. As a result, a lyophobic layer 153 is formed as shown in FIG. 15B. The bank for source and drain 148 is formed, which has the lyophobic layer 156 formed on its top surface, as shown in FIG. 16C.

FIG. 17A is a view corresponding to reducing lyophobic property in step S32, exposure to light in step S33, and developing in step S34. The lyophobic layer 156 on the surface of the bank for source and drain 148 is selectively irradiated with excimer UV light having a wavelength of 172 nm, for example, by using a mask, reducing the lyophobic property in the irradiated portion. The lyophobic property due to the lyophobic layer 156 has little effect in the irradiated portion. Next, in step S33, the bank for source and drain 148 is exposed to light by using the same mask as used in step S32. In the embodiment, the light source is a xenon lamp and the amount of energy of irradiating light is about 40 mJ/cm². In addition, reducing lyophobic property and developing may be performed at the same time by using the same device as used in the second embodiment.

Subsequently, in step S34, the exposed substrate 141 is developed to selectively remove the portion exposed to light of the bank for source and drain 148. For example, developing is performed at a temperature of 28° C. for about 4.5 minutes by using a TMAH liquid having a concentration of 2.38%, for example. As a result, the concave sections 151 and 152 passing through from the surface of the bank for source and drain 148 to the top surface of the polysilicon layer 143 are formed, as shown in FIG. 17A. The irradiated portion of the bank for source and drain 148 is easily removed since the lyophobic property due to the lyophobic layer 156 has little effect in the portion to be developed by the reduction in step S32.

FIG. 17B is a view corresponding to placing a functional liquid for source and drain in step S35. In step S35, ink for source and drain wiring pattern 157 (functional liquid) is discharged and applied into the concave sections 151 and 152 of the bank for source and drain 148 by using the droplet discharging device IJ. Ink composed of an organic silver compound using diethylene glycol diethylene ether as the dispersion medium is adopted as the ink for source and drain wiring pattern 157 (functional liquid) in the embodiment. As a result, the ink for source and drain wiring pattern 157 is applied to the concave sections 151 and 152 of the bank for source and drain 148, as shown in FIG. 17B.

FIG. 17C is a view corresponding to burning in step S36. In step S36, the bank for source and drain 148 and the ink for source and drain wiring pattern 157 are burned by a clean oven in a nitrogen ambient. Burning conditions are, for example, a burning temperature of 200° C. and burning time of 60 minutes. As a result, the bank for source and drain 148, the source electrode 149, and the drain electrode 150 are burned and formed, as shown in FIG. 17C.

As described above, the embodiment has the following effects in addition to the effects in the first and fourth embodiments.

(1) According to the embodiment, a photosensitive olefin resin liquid containing an organic olefin resin, which is an organic material, is adopted for the bank for source and drain 148. Therefore, wiring of high-quality with little residue remaining in the periphery of the source wiring and the drain wiring is obtained since the lyophobic layer 156 has high lyophobic property as compared to forming a bank from an inorganic material.

(2) According to the embodiment, a photosensitive olefin resin liquid, which is an organic material, is adopted for the bank for source and drain 148. Adoption of a solution containing an organic material as the photo resist liquid can lead to forming high lyophobic property of the lyophobic layer, compared to adoption of a solution containing an inorganic material. With high lyophobic property of the lyophobic layer 156, when the ink for source and drain wiring pattern 157 applied to the concave sections 151 and 152 is not completely fallen into the concave sections 151 and 152, the ink does not move to the surface of the lyophobic layer 156 but is raised. Therefore, a large amount of the ink for source and drain wiring pattern 157 can be applied compared to the lyophobic layer 156 having low lyophobic property. With low lyophobic property of the lyophobic layer 156, a large amount of the ink for source and drain wiring pattern 157 cannot be applied at the same time. Therefore, if a thick film is formed in the concave sections 151 and 152, it is necessary to increase the number of repeating the process of placing a functional liquid and the process of intermediate drying. On the other hand, with high lyophobic property of the lyophobic layer 156, a large amount of the ink for source and drain wiring pattern 157 can be applied at the same time. Therefore, the number of repeating the process of placing a functional liquid and the process of intermediate drying can be reduced for the source electrode 149 and the drain electrode 150, compared to adoption of an inorganic material for the bank for source and drain 148, allowing the source and drain electrodes to be manufactured with improved productivity.

(3) According to the embodiment, a photosensitive olefin resin liquid, which is an organic material, is adopted for the bank for source and drain 148. If a solution containing an inorganic material as the photo resist liquid serving as a material for forming a bank is adopted, the thickness of the photo resist layer must be 1 to 2 μm or less since a thick photo resist film causes a crack to occur in the photo resist film during the burning process. If a solution containing an organic material as the photo resist liquid serving as the material for forming a bank, the thickness of the photo resist layer can be increased up to about 5 to 8 μm since a thick photo resist film is unlikely to cause a crack.

If a structure such as an element or wiring of about 4 μm on the substrate 141, the structure can be buried and the its top surface can be flattened with the bank for source and drain 148. Accordingly, in a liquid crystal display, for example, the structure on the substrate 141 can be buried with the bank for source and drain 148 when a flat electrode is placed on the top surface of the bank for source and drain 148. This makes it easy to design placement of elements on the substrate 141.

Photosensitive polysilazane containing an inorganic material is adopted for the bank for gate 146 in the embodiment, but a photosensitive organic material containing an organic material and either a photoacid generator or photobase generator may be adopted. At this point, the heat resistance of the bank for gate 146 decreases compared to when an inorganic material is adopted. Therefore, when the burning temperature of the bank for gate 146 is; for example, about 200° C., the lyophobic property of the lyophobic layer 153 sometimes does not sufficiently decrease in the burning process. In this case, the process of reducing lyophobic property may be provided between the process of burning and the process of placing a bank for source and drain so that the lyophobic layer 153 is irradiated with excimer UV light. A material liquid of the bank for source and drain can be applied so as to provide an even film thickness in the process of placing a bank for source and drain since the material is not affected by repellency of the lyophobic layer 153.

### Other Embodiments

Next, a liquid crystal display, which is an example of the electro optic device according to one embodiment of the invention, will be described. The liquid crystal display of the embodiment includes a TFT with circuit wiring that is formed by using the method described in the first, second, and fourth embodiments.

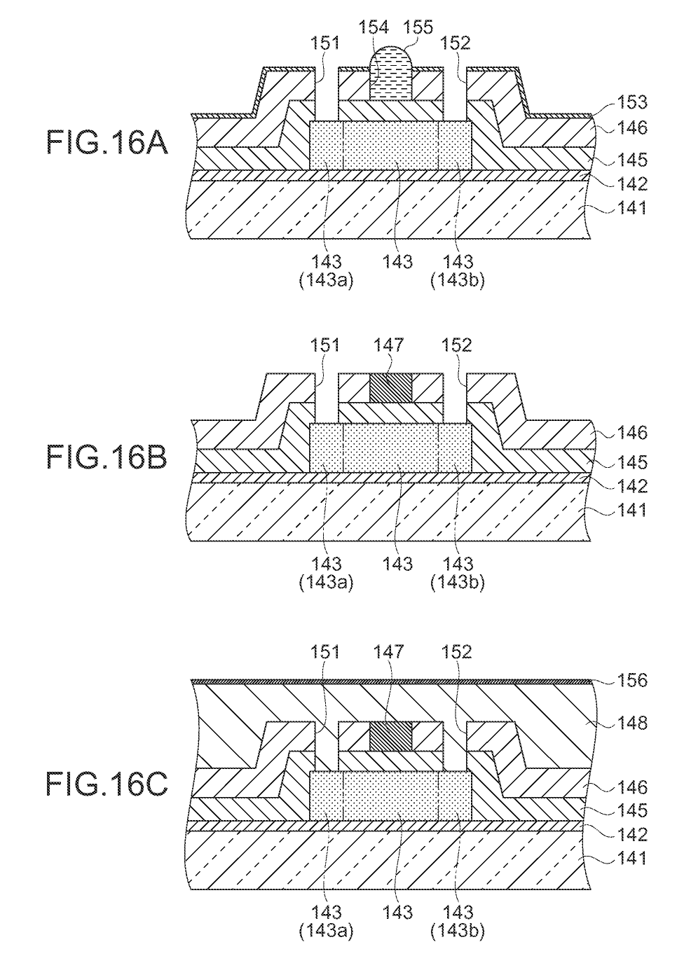

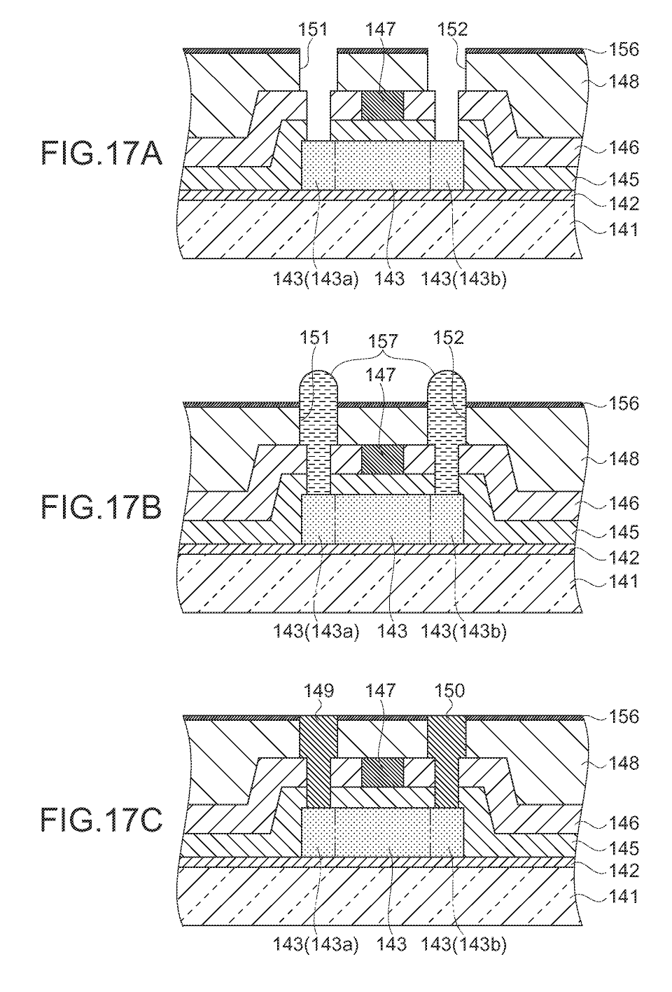

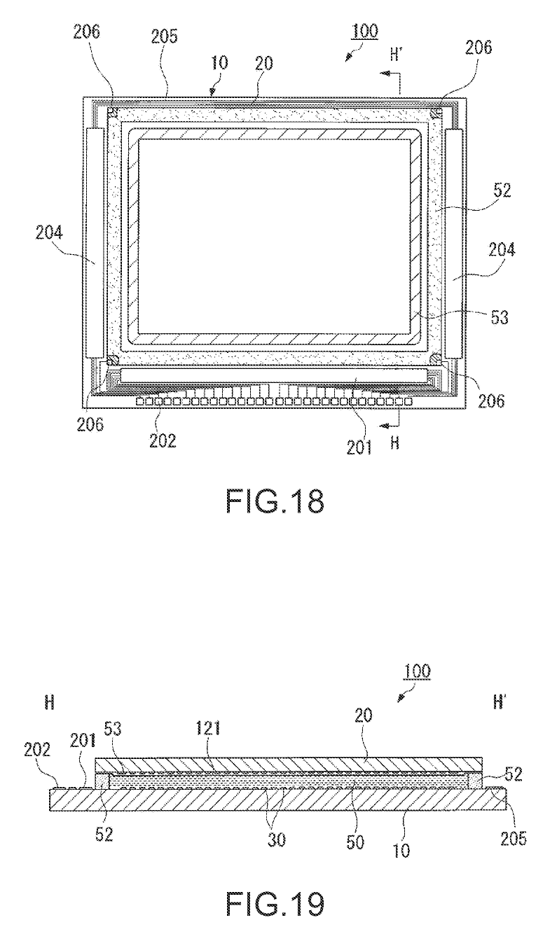

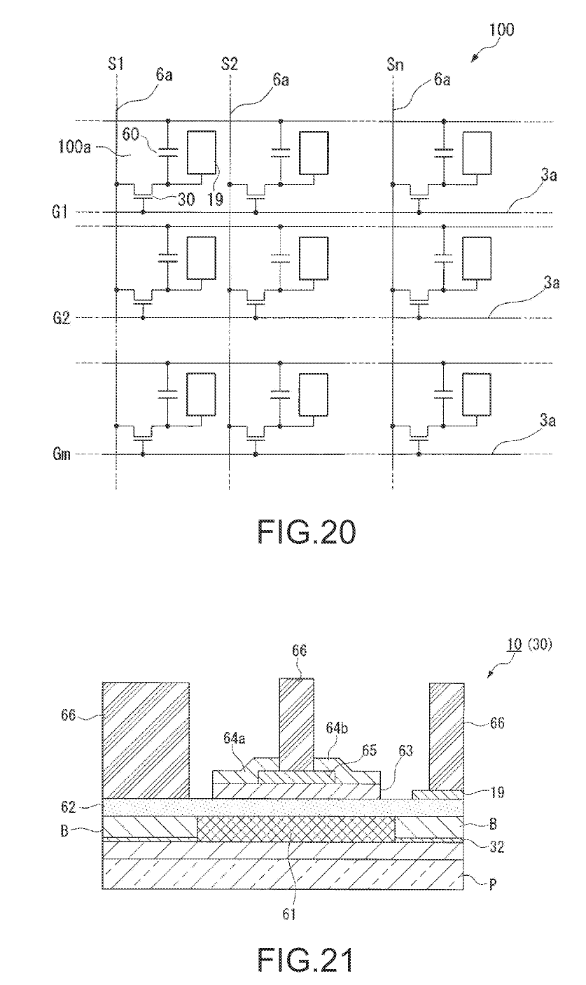

FIG. 18 is a plan view showing a liquid crystal display according to the embodiment with its elements, seen from the side of the opposing substrate, and FIG. 19 is a sectional view taken along the line H-H′ in FIG. 18. FIG. 20 is an equivalent circuit diagram showing various elements and wiring in a plurality of pixels formed in a matrix in the image display region of the liquid crystal display, and FIG. 21 is a partial enlarged view of the liquid crystal display. Here, in each of figures used for the following description, contraction scales of layers and parts may be different so as to have recognizable size on each of figures.

In FIGS. 18 and 19, a liquid crystal display (electro optic device) 100 of the embodiment mainly includes a thin film transistor (TFT) array substrate 10 and an opposing substrate 20, which are paired, and a sealing member 52, which is a photopolymerizing sealing member. The TFT array substrate 10 is attached to the opposing substrate 20 by means of the sealing member 52, and liquid crystal 50 is sealed and maintained in the partitioned region by the sealing member 52. The sealing member 52 is formed in a closed frame shape in the substrate surface.

Inside the sealing member 52, the peripheral partition 53 made of a light blocking material is formed. Outside the sealing member 52, a data line driving circuit 201 and mounting terminals 202 are formed along one side of the TFT array substrate 10. Scanning line driving circuits 204 are formed along both sides adjacent to this side. A plurality of pieces of wiring 205 are placed along the only remaining side of the TFT array substrate 10, and connect the scanning line driving circuits 204 placed at the both sides of the image display region. Conductive members between substrates 206 to electrically connect the TFT array substrate 10 with the opposing substrate 20 are placed at least at one of corners of the opposing substrate 20.

Instead of forming the data line driving circuit 201 and the scanning line driving circuit 204 on the TFT array substrate 10, for example, a tape automated bonding (TAB) substrate on which an LSI for driving is mounted may be electrically and mechanically connected to a group of terminals formed on the periphery of the TFT array substrate 10 through an anisotropic conductive film. In the liquid crystal display 100, a retardation film, a deflecting plate, and others are placed in a predetermined direction depending on the kind of the liquid crystal 50 used, namely depending on the operation mode such as twisted nematic (TN) mode or super twisted nematic (STN) mode, or depending on whether normally white mode or normally black mode is used (not shown in the figure). If the liquid crystal display 100 is used for color display, on the opposing substrate 20, for example, red (R), green (G), and blue (B) color filters with their protective films are formed in the regions that are opposite to pixel electrodes to be described later on the TFT array substrate 10.

In the image display region of the liquid crystal display 100 having such a structure, a plurality of pixels 100a are formed in a matrix, as shown in FIG. 20 In each of these pixels 100a, a TFT for pixel switching (switching element) 30 is formed and a data line 6a to supply pixel signals S1, S2, . . . , Sn is electrically connected to the source of the TFT 30. Pixel signals S1, S2, . . . , Sn may be supplied to the data line 6a in this sequential order, or may be supplied by group of the signals to a plurality of data lines 6a located adjacent to one another. A scanning line 3a is electrically connected to the gate of the TFT 30, which applies scanning pulse signals G1, G2, . . . , Gn to the scanning line 3a in the sequential order at a predetermined timing.

A pixel electrode 19 is electrically connected to the drain of the TFT 30. The TFT 30 as a switching element is turned on for a predetermined time period so that pixel signals S1,S2, . . . , Sn supplied from the data line 6a are written to the pixel electrode 19 at a predetermined timing. Pixel signals S1, S2, . . . , Sn at a predetermined level written to a liquid crystal via the pixel electrode 19 as described above are maintained for a predetermined time period between the pixel electrode 19 and an opposing electrode 121 on the opposing substrate 20 shown in FIG. 19. A storing capacitor 60 is arranged in parallel with a liquid crystal capacitance formed between the pixel electrode 19 and the opposing electrode 121. This capacitor is provided to avoid leak of maintained image signals. For example, the voltage of the pixel electrode 19 is maintained in the storing capacitor 60 for a time period, which is three digits longer than the time for application of the source voltage. Thus, the maintaining characteristics of charge improve and the liquid crystal display 100 having a high contrast ratio can be attained.

Gate wiring, a gate electrode, source wiring, a source electrode, a drain electrode, and others of the liquid crystal display 100 are formed by the method of forming a film pattern according one embodiment of the invention. The circuit wiring film 33 of high quality is formed since no residue remains in the concave section 34 of the bank B. Accordingly, the gate wiring, gate electrode, source wiring, source electrode, and drain electrode of high quality corresponding to the circuit wiring film 33 are formed.

FIG. 21 is a partial enlarged view of the liquid crystal display 100 with the bottom gate type TFT 30. On the glass substrate P constituting the TFT array substrate 10, gate wiring 61 is formed between the banks B by the method of forming circuit wiring of the above-described embodiments.

An active layer 63, which is a semiconductor film composed of an amorphous silicon (a-Si) layer, is stacked on the gate wiring 61, holding a gate insulating film 62 made of SiNx therebetween. Part of the semiconductor layer 63 opposing to the above-mentioned gate wiring part is a channel region. Junction layers 64a and 64b composed of, for example, n+ type a-Si layer are formed on the semiconductor layer 63 in order to obtain the ohmic junction. An insulating etch stop film 65 made of SiNx for protecting the channel is formed on the active layer 63 at the center of the channel region. Resist coating, exposure to light and developing, and photoetching are applied to these gate insulating film 62, active layer 63, and etch stop film 65 after they are deposited (CVD), thereby patterning them as shown in the figure.

Further, the junction layers 64a and 64b and the pixel electrode 19 made of indium tin oxide (ITO) are similarly formed and photoetching is applied to them, thereby patterning them as shown in the figure. Banks 66 protrude on the pixel electrode 19, the gate insulating film 62, and the etch stop film 65, and droplets of silver compound are discharged by using the above-described droplet discharging device IJ. Thus, a source line and a drain line can be formed between the banks 66.

The TFT 30, which is one embodiment of a device according to the invention, is used as a switching element for driving the liquid crystal display 100 in the above-described embodiments, but can also be applied to devices other than the liquid crystal display, such as an organic electroluminescent (EL) display device. The organic EL display device is an element in which thin films including a fluorescent inorganic or organic compound are sandwiched between an anode and a cathode. When electrons and holes are injected into the thin films for recombination, excitons are generated. The device emits light by utilizing light (fluorescence and phosphorescence) that is released when the excitons are deactivated. Among fluorescent materials used for the organic EL display element, materials exhibiting luminescent colors of read, green, and blue, namely a material for forming a light emitting layer and materials for forming a hole injection layer and an electron transport layer, are placed as the ink on the substrate with the TFT 30, and patterned. A full-color self light emitting EL device can thereby be manufactured. Such an organic EL device is included in the scope of the electro optic device according to one embodiment of the invention.

As the electro optic device according to one embodiment of the invention, a plasma display panel (PDP), a surface-conduction electron-emitter utilizing a phenomenon that a current passes through a thin film having a small area formed on the substrate while flowing in parallel to the surface of the film so as to emit electrons can be mentioned in addition to the above-described example.

These electro optic devices have good characteristics and good productivity since they include semiconductor devices having good characteristics and good productivity.

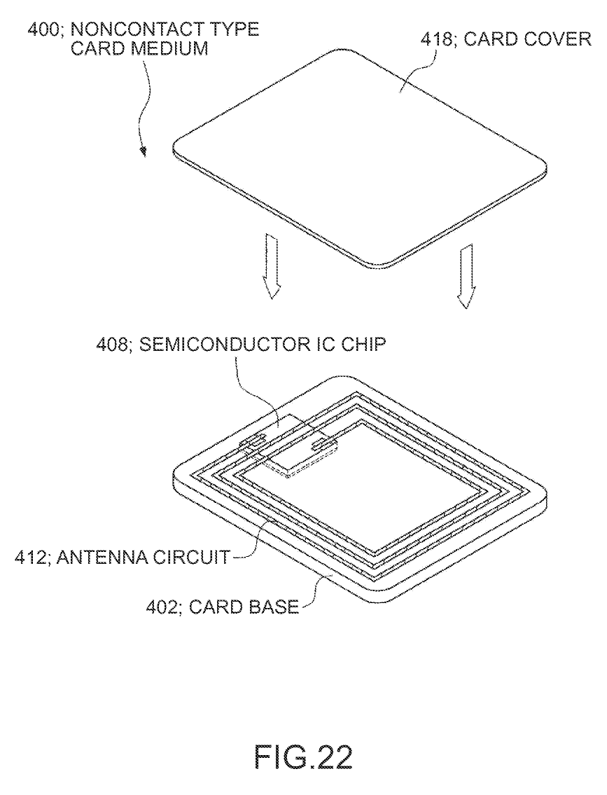

Another embodiment of a noncontact type card medium, in addition to the embodiment of forming a semiconductor device, will be described. As shown in FIG. 22, a noncontact type card medium (electronic apparatus) 400 according to the embodiment, in which a semiconductor integrated circuit (IC) chip 408 and an antenna circuit 412 are integrated into a package consisting of a card base 402 and a card cover 418, performs at least one of power supply and transmitting and receiving data with an outer transceiver (not shown) by using at least one of electromagnetic wave and electrostatic capacitory coupling. The antenna circuit 412 is formed by the method of forming a wiring pattern according to the above-described embodiments.

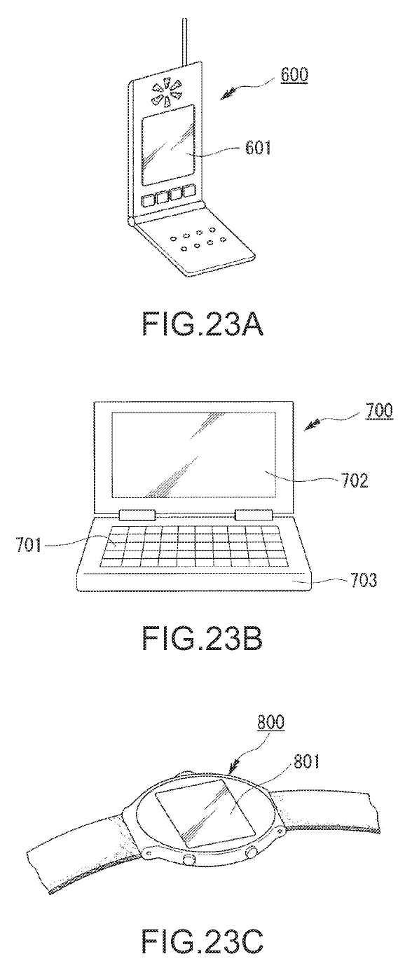

FIG. 23A is a perspective view showing an example of a cellular phone, which is an example of an electronic apparatus. In FIG. 23A, reference numeral 600 denotes the main body of the cellular phone, and numeral 601 denotes a liquid crystal display unit with the liquid crystal display 100 of the above embodiment.

FIG. 23B is a perspective view showing an example of a portable type information processing device such as a word processor and a personal computer. In FIG. 23B, reference numeral 700 denotes an information processing device, numeral 701 denotes an input unit such as a keyboard, numeral 703 denotes the main body of the information processing device, and numeral 702 denotes a liquid crystal display unit with the liquid crystal display 100 of the above-described embodiment.

FIG. 23C is a perspective view showing an example of a wrist watch type electronic apparatus. In FIG. 23C, reference numeral 800 denotes the main body of the watch, numeral 801 denotes a liquid crystal display unit with the liquid crystal display 100 of the above-described embodiment,

Electronic apparatuses shown in FIGS. 23A to 23C have good characteristics and good productivity since they include liquid crystal display 100 (electro optic device) having good characteristics and good productivity. In addition, the electronic apparatuses of the embodiment include a liquid crystal device, but may include another electro optic device such as an organic EL display device or plasma type display device.

In the above-described embodiments, a conductive film is formed in a concave section formed between the banks B, forming a wiring pattern. However, the film that can be formed is not limited to the wiring pattern composed of a conductive thin film. For example, the film may have applicability to a color filter that is used to colorize a displayed image in a liquid crystal display. The color filter can be formed by placing functional liquids (liquid materials) of red (R), green (G), and blue (B) as droplets in a predetermined pattern on a substrate.

Similarly to the embodiment described above, banks corresponding to the shape of a color filter are formed on a substrate, and a functional liquid is placed in a groove formed by the banks, forming the color filter. Thus, a liquid crystal display with a color filter can be manufactured.

Further, the insulating film 29 and the pixel electrode 19 described in the above embodiments can be formed by applying the method of forming a film pattern according to one embodiment of the invention.

What is claimed is:

1. A method of forming a bank that partitions a region for forming a film pattern made of a functional liquid; comprising:
forming a bank film made of a photo resist by applying a photo resist liquid onto a substrate and drying the photo resist liquid;
performing a lyophobic treatment for the bank film by using a lyophobic treatment gas and plasma;
reducing a lyophobic property by selectively applying ultraviolet rays to the bank film after the lyophobic treatment with a mask;
selectively exposing the bank film after the lyophobic treatment to light with the mask;
developing and patterning the bank film after reducing the lyophobic property and exposing the bank film to light so as to form the bank;
wherein the lyophobic property is reduced and the bank film is exposed to light continuously or at the same time with the same mask.

2. The method of forming a bank according to claim 1, wherein if the lyophobic property is reduced and the bank film is exposed to light continuously with the same mask, the bank film is exposed to light after the lyophobic property is reduced.

3. The method of forming a bank according to claim 1, wherein a photosensitive material including any one of polysilazane, polysilane, and polysiloxane and either a photoacid generator or a photobase generator and functions as a positive photo resist is used as the photo resist material liquid.

4. The method of forming a bank according to claim 1, wherein a photosensitive material including an organic material and either a photoacid generator or a photobase generator and functions as a positive photo resist is used as the photo resist material liquid.

5. A method of forming a film pattern by using the bank obtained by the method of forming a bank according to claim 1, placing a functional liquid in the region for forming a film pattern partitioned by the bank, and drying the functional liquid.

6. A semiconductor device comprising the film pattern obtained by the method of forming a film pattern according to claim 5.

7. The semiconductor device according to claim 6,
wherein the semiconductor device constitutes a transistor having a coplanar structure;
wherein the film pattern constitutes a source electrode and a drain electrode; and
wherein a material including an organic material is used as the photo resist material liquid.

8. An electro optic device comprising the semiconductor device according to claim 6.

9. An electronic apparatus comprising the electro optic device according to claim 8.
